(19) United States
(12) Patent Application Publication
(10) Pub. No.: US 2015/0320158 A1
(43) Pub. Date: Nov. 12, 2015

(54) ARTICLES OF JEWELRY CONTAINING A PERSONALIZING ADDITIVE SUCH AS DNA AND METHODS OF MAKING

(71) Applicant: Chamber Works, LLC, Wilmington, DE (US)

(72) Inventors: Patrick Joseph Duffy, JR., Kennnett Square, PA (US); Ellen Dias Jorgensen, South Salem, NY (US); Edith Mathiowitz, Brookline, MA (US); Christopher Bagnall, Greensburg, PA (US)

(21) Appl. No.: 14/657,734

(22) Filed: Mar. 13, 2015

Related U.S. Application Data
(60) Provisional application No. 61/953,000, filed on Mar. 14, 2014.
(60) Provisional application No. 62/005,745, filed on May 30, 2014.

(51) Int. Cl. A44C 27/00; B22F 3/02; B29C 39/10; B22F 3/10; B29C 39/00; B22F 1/00; B22F 7/06

(52) U.S. Cl. CPC A44C 27/002; B22F 1/00; B22F 3/02; B22F 7/06; B22F 3/10; B29C 39/003; B29C 39/10; B33Y 10/00

(57) ABSTRACT

The present invention relates to jewelry or a metal composition containing an additive or personalizing substance such as a nucleic acid, sand or other suitable component intended to have personal significance to the wearer. A nucleic acid personalizing substance may comprise human DNA of amplified repeat sequences. The jewelry may be made by using a cold or warm metallurgical technique. Prior to being integrated into the article of jewelry, the additive may be encapsulated to provide a protective layer around the personalizing substance. The protective layer can prevent degradation of the personalizing substance during manufacture of the article of jewelry. The personalizing substance can also be added to a polymer solution which is cast to form a continuous matrix of polymer including the personalizing substance.

### CROSS REFERENCE TO RELATED APPLICATIONS

This application claims the benefit of Provisional U.S. Patent Application Ser. No. 61/953,000, filed Mar. 14, 2014, pending, and Provisional U.S. Patent Application Ser. No. 62/005,745, filed May 30, 2014, pending. Each of the above referenced applications is incorporated by reference herein in its entirety.

Pursuant to the provisions of 37 C.F.R. §1.52(e)(5), the sequence listing text file named 103062_Seq_Lstng.txt, created on Mar. 13, 2015 and having a size of 764 bytes, and which is being submitted herewith, is incorporated by reference herein in its entirety.

### BACKGROUND

1. Field

The present invention relates to jewelry containing a personalizing additive such as DNA, sand or another component or memento having personal significance to the wearer of jewelry.

2. Background of the Technology

Since ancient times, humans have used symbols to communicate, whether obvious or cryptic. Among such symbols is jewelry in any of its many forms to symbolize wealth, status, personal expressions of beauty or taste, declarations of affection, signs of religious beliefs, and physical connection to a person, place or event of which the jewelry is reminiscent.

The personalized jewelry of the invention discloses a type of jewelry providing a unique physical connection with a person or place or event by incorporating a personalizing substance, for example, a nucleic acid such as DNA from a person or pet or other life form, or a physical remnant such as an extract or fragment or sand or plant tissue associated with an object, place or event in a way that protects the personalizing substance while integrating the personalizing substance into the gold or silver or other metal from which the jewelry is formed.

Jewelry in the form of a hollow container encasing cremated remains of a person or pet has been described in the art. Such containers are described, for example, in U.S. Pat. No. 5,755,116, which discloses one or more decorative chambers for enclosing remains wherein the complementary parts of the chamber are connected and sealed using silicon sealant or threads. The chamber is suitable for incorporation into a necklace or bracelet. U.S. Pat. No. 8,281,465 discloses a single-chambered, dimensionally-adjustable three-part container suitable for containing a small sample of ashes or other form of DNA material from human or other animal. U.S. Patent Application Publication No. 2005/0081561 discloses a container made from two complementary parts each of which comprises a sacrificial lip suitable for laser-welding to form a hermetically sealed chamber.

Remains of the deceased also have been incorporated into gems. For example, U.S. Patent Application Publication No. 2010/0005835 A1 discloses a pearl comprising cremated remains surrounded by nacre and a method for creating the pearl comprising providing a nucleus containing cremated remains and inserting the nucleus into a mollusk.

Gemstones containing human or animal material likewise are known in the art. U.S. Pat. No. 7,228,602 and U.S. Patent Application Publication No. 2009/0266108 A1 disclose methods to create diamonds or other gemstones containing cremated remains whereby passageways are drilled into a gemstone and cremated remains or hair or DNA is inserted into the passageway, optionally mixed with chemical compounds. Alternatively, U.S. Pat. No. 7,255,743 discloses a method for collecting carbon from the remains of a deceased human or animal and creating gems from the carbon using crystal growth sublimation

In a divergent method from the above, U.S. Pat. No. 5,987,720 discloses a portable tomb comprising a solid plastic block into which is imbedded prior to polymerization of the plastic various memorabilia prized by the deceased, information about the deceased including electronically stored sound and images, and tissue biopsied from the deceased and preserved by fixation and drying for future resurrection of a clone of the deceased from the mummified DNA.

U.S. Pat. No. 6,382,111, U.S. Pat. No. 6,615,463 and U.S. Patent Application Publication No. 2007/0000351 A1 disclose combining cremation residue, which primarily is inorganic, with glass, clay, commercially available precious metal clay mixture, polymers and so forth to solidify the ash and bone, and to incorporate the remains into artwork, jewelry, and the like.

The differences in the DNA between individual humans gives rise to unique DNA profiles that can be used to distinguish individuals. Analysis of highly variable regions of the human genome, also known as polymorphic genetic markers, has contributed to the development of a variety of applications such as forensic DNA analysis and paternity testing that are used to unambiguously identify individuals.

The ability to mix personalized DNA or other organic molecules with pure precious metal for the manufacture of personalized jewelry would be desirable. While each of the above publications or patents addresses preserving and incorporating into useful or decorative objects human or animal remains, usually in the form of cremated remains, and some mention the idea of inserting DNA into cavities in jewelry or plastic, none disclose or suggest integrating DNA or other organic material and precious metal to make jewelry.

### SUMMARY

A composition is provided which comprises:

a metal powder; and

a personalizing substance.

The personalizing substance can be a biological material such as DNA.

A method is also provided which comprises:

encapsulating biological material in a polymer;

mixing the encapsulated biological material with a metal powder; and

forming the resulting mixture into a metal article incorporating the encapsulated biological material;

wherein the encapsulated biological material is integrated into and retains its structural integrity in the metal article.

A method of incorporating a biological material into metal comprising:

encapsulating the biological material in a polymer;

forming the metal around the encapsulated genetic material to encase the genetic material;

wherein the metal is formed around the encapsulated biological material using a cold, warm or hot metallurgical process; and

wherein the encapsulated biological material is integrated into and retains its structural integrity in the metal article

A metal article is provided which comprises:

a biological material; and

a metallic body;

wherein the metallic body is formed around the biological material such that the biological material is encased in the metallic body.

An article of manufacture is provided which comprises:

polymer encapsulated biological material;

wherein the polymer encapsulated biological material is contained in a rigid capsule.

A method is also provided which comprises:

dispersing a personalizing substance in a polymer solution;

casting the polymer solution containing the personalizing substance;

subsequently removing the solvent to form a polymer article incorporating the personalizing substance.

According to some embodiments, casting comprises casting the polymer solution containing the personalizing substance into a cavity in a metallic article of jewelry. According to some embodiments, casting comprises casting the polymer solution containing the personalizing substance into a cavity of a mold.

These and other features of the present teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 illustrates variation in the D21S11 marker between ten individuals, as shown by an electrophoretic separation on a polyacrylamide gel of the D21S11 PCR amplification product.

FIG. 2 illustrates variation in the D5S818 marker between ten individuals, as shown by an electrophoretic separation on a polyacrylamide gel of the D5S818 PCR amplification product.

FIG. 3 illustrates representative genotyping of a group of tetranucleotide and pentanucleotide PCR products from an individual, including D21S11 and D5S818 shown in FIGS. 1 and 2, respectively.

FIGS. 4A and 4B are photographs showing small cylinders produced from copper powder using uniaxial pressing.

FIG. 5 is a photomicrograph showing polymer encapsulated DNA.

FIG. 6 is a graph showing the safe exposure time in minutes as a function of temperature for DNA.

FIG. 7 is a photomicrograph showing a quartz bead which can be used for encapsulating polymer encapsulated DNA.

FIG. 8 is a schematic illustrating insertion of a quartz bead containing polymer encapsulated DNA in a pre-drilled axial cavity in a ring.

FIGS. 9A-9E show the results of a trial conducted with a thermocouple embedded in a quartz capsule and contained in a pressed copper powder cylinder to monitor temperature during a 3D printing process using gold powder.

FIG. 10A is a photograph showing a quartz capsule containing polymer encapsulated

DNA wherein a clay filler is used to plug the openings in the quartz capsule.

FIGS. 10B-10E are photographs showing the direct metal laser sintering (DMLS) of a rose gold powder to form an metallic article of jewelry enclosing the quartz capsule containing polymer encapsulated DNA of FIG. 10A.

FIG. 11A is a photograph showing the recovery of the quartz capsule containing polymer encapsulated DNA from the metallic article of jewelry.

FIG. 11B is a photograph which shows polymer encapsulated DNA microparticles under phase contrast microscopy and with UV fluorescence.

FIG. 12 is a schematic showing a ring having an inner band of a continuous matrix of material containing dispersed DNA.

FIGS. 13A-13C are photographs showing various articles of jewelry that can be made from a continuous matrix of material containing dispersed DNA.

### DESCRIPTION OF THE VARIOUS EMBODIMENTS

Definitions

As used herein, the term “personalizing substance” refers to a material of significance to an individual. The personalizing substance may be a natural or synthetic material, where at least a portion of the material is capable of being encapsulated in a polymeric microcapsule. The term personalizing substance is used herein to refer to the material both prior to and subsequent to encapsulation.

As used herein, a “precious metal” metal is a rare, naturally occurring metallic chemical element of high economic value. Exemplary and non-limiting examples of precious metals include gold, silver, platinum, palladium ruthenium, rhodium, osmium, and iridium.

As used herein, “additive manufacturing” or (AM) refers to any of various processes used to make a three-dimensional object. Exemplary AM processes for forming 3D metal objects include, but are not limited to, selective laser sintering, direct metal laser sintering, and selective laser melting as well as 3D printing.

As used herein, the term “hydrophobic polymer” refers to polymers that have a low affinity for water (at physiological temperature, e.g. 37° C.) and have a lower solubility in water than polylactic acid (PLA).

As used herein, the term “high molecular weight” means a molecular weight above 10,000 Daltons (Da), preferably above 20,000 Da.

As used herein, the term “encapsulated material,” means the molecular components of the personalizing substance. For example, if the personalizing substance is sand, then the encapsulated material includes silica (SiO₂), calcium silicate (Ca₂SiO₄), calcium nitride (CaN₂), and/or silicon nitride (Si₃N₄), etc.

As used herein, the term “biological material” means any biological substance, including, but not limited to biological micromolecules, such as a nucleotides, amino acids, cofactors, or hormones, biological macromolecules, such as nucleic acids, polypeptides, proteins (for example enzymes, receptors, secretory proteins, structural and signaling proteins, hormones, ligands, etc.), polysaccharides, and/or any combination thereof.

As used herein, “nanoparticle” refers to a particle or a structure in the nanometer (nm) range, typically from about 1 to about 1000 nm in diameter.

As used herein, a “microparticle” is a particle of a relatively small size, but not necessarily in the micron size range; the term is used in reference to particles of sizes that can be, for example 1 to about 1000 microns. The term “microparticle” encompasses microspheres, microcapsules and microparticles, unless specified otherwise. A microparticle may be of composite construction and is not necessarily a pure substance; it may be spherical or any other shape.

As used herein, the term “percent loading” refers to a ratio of the weight of a personalizing substance to the weight of a microparticle, multiplied by 100.

Jewelry incorporating a personalizing substance is described. The personalizing substance can be an organic material, such as DNA or cremation remains, or an inorganic material, such as sand, having personal significance to the wearer of the jewelry. The jewelry can be manufactured using a cold or a warm metallurgical process. The personalizing substance can be encapsulated prior to being incorporated into the article of jewelry. The encapsulation material can prevent the degradation of the personalizing substance during manufacture. A method of preparing the encapsulated personalizing substance is also described.

Personalizing Substance

As described herein, a personalizing substance can be integrated into a precious metal used in the manufacture of jewelry. Suitable personalizing substances include, but are not limited to, biological materials such as, for example, animal or plant tissue, sand, soil, metal, sea water, holy water, synthetic or natural polymers, cremated ash, ceramics, and other physiologically compatible components. In the case of liquid personalizing substances such as sea water and holy water, lyophilization of microparticles comprising the personalizing substance would remove any liquid contained in the microparticle. However, any salts or other non-volatile compounds contained in the liquid would remain.

The personalizing substance can be selected from an organic material from a human or animal or plant, preferably having personal significance to the wearer of the material object, and an organic or inorganic material preferably relating to a place or event having personal significance to the wearer of the material object.

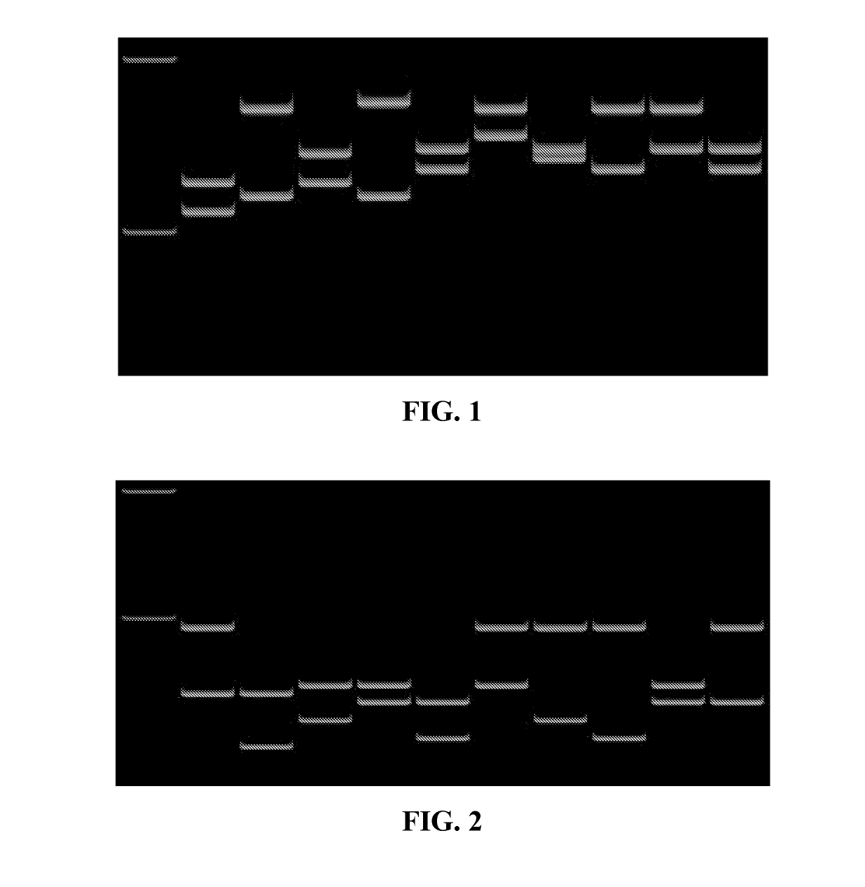

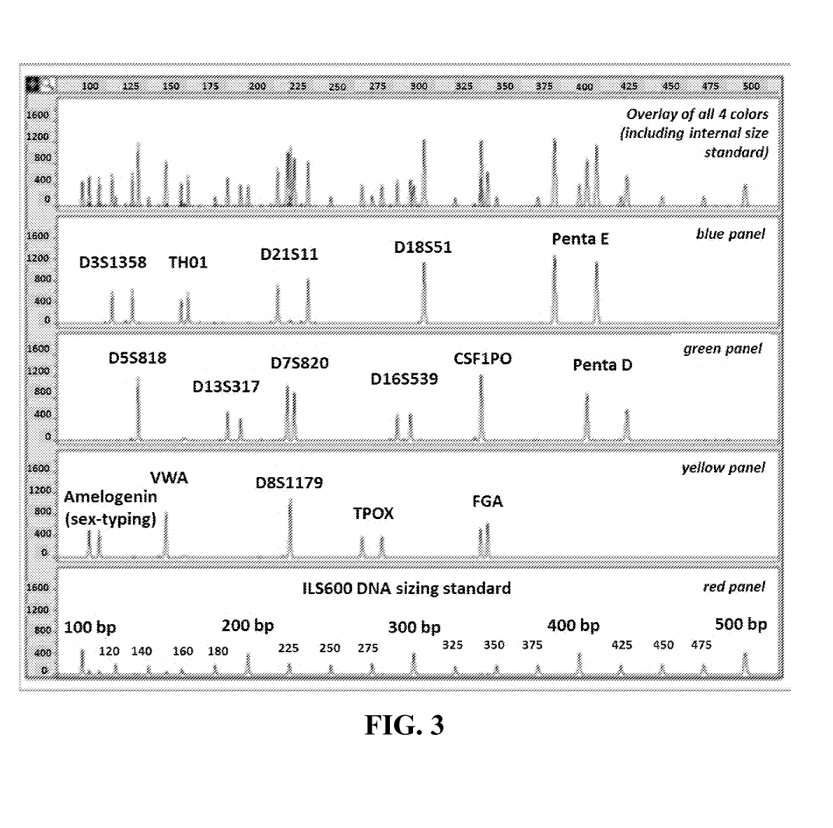

The personalizing substance may preferably consist of or include a polynucleotide from an animal, including a human, or a plant or a microbe. Preferably, the polynucleotide is DNA from a human or plant. More preferably, the human DNA is tetranucleotide repeat DNA sequences from the genome of one or more humans. The DNA can be amplified by any suitable means such as the polymerase chain reaction (PCR). Because the size of PCR products from human tetranucleotide repeat regions typically varies between individuals, tetranucleotide repeats are a preferred personal identification molecule for incorporation into personalized jewelry. Two different tetranucleotide PCR products that were analyzed from ten individuals are shown in FIGS. 1 and 2. In each lane of the gels, PCR products of two different sizes are observed based on the inheritance for each individual of one copy of the polymorphic marker from each parent. Each inherited copy contains a variable number of tetranucleotide repeats. The PCR products differ in size by four base pairs, e.g., 201, 205, 209 . . . 251, 257 base pairs. Thus, two unrelated individuals likely will produce different sized PCR products from the same tetranucleotide polymorphic marker. As a greater number of different tetranucleotide repeat regions are compared between individuals, the probability of those individuals sharing the identical electrophoresis migration pattern decreases.

Multiple DNA segments for tetranucleotide PCR amplification typically may be amplified in a single tube. The multiple amplification of several DNA regions is known in the art as multiplex PCR. The multiple PCR products are separated as known in the art, for example, by electrophoresis, and an instrument “reads” the electrophoresis gel or image to automatically analyze the sizes of the PCR products. A representative example of genotyping results from a group of tetranucleotide and pentanucleotide PCR products is presented in FIGS. 1 and 2.

In some embodiments, the compositions may contain encapsulated DNA without any additional personalizing substances. In other embodiments, the compositions contain a personalizing substance comprising DNA and one or more additional personalizing substances comprising other compounds. For example, the additional personalizing substances may be one or more samples from sand, soil, metal, ceramics, and/or plant products.

Exemplary personalizing substances include, but are not limited to, sand, soil or rock particles, or compounds extracted from sand, soil or rock.

Sand consists predominately of silica (SiO₂) and other organic and inorganic minerals, such as calcium silicate (Ca₂SiO₄), calcium nitride (Ca₃N₂), silicon nitride (Si₃N₄), aluminum nitride (AlN₃), alumina (Al₂O₃), borazone “boron nitride” (BN), magnesium oxide (MgO), silicon oxysulfide (SiOS), lithium silicate (Li₂SiO₄), as well as other metal oxides/nitrides, as shown in Table 1.

The identity of personalizing substances that do not contain DNA, such as sand, soil, metal, water, sea water, holy water, synthetic or natural polymers, cremated ash, ceramics, and compounds derived from plants, may be confirmed by a suitable method, such as mass spectrometry, for example, isotope-ratio mass spectrometry (IRMS) or liquid chromatography mass spectrometry (LC-MS).

TABLE 1
Exemplary Personalizing Substances

| Source for | |
|---|---|
| Personalizing | |
| Substance | Personalizing Substance |
| White Beach Sand | Quartz (SiO₂) particles of different diameter |
| | ranges and limestone from coral or shells. |
| Dark Sand | Quartz (SiO₂) particles of different diameter |
| | ranges and magnetite. |
| Green Sand | Quartz (SiO₂) particles of different diameter |
| | ranges and chlorite |
| Rock | Quartz (SiO₂) particles of different diameter ranges |
| | and other trace elements that vary with |
| | geographical location. |

For example, the personalizing substance may contain silicon dioxide particles extracted from a soil or rock sample. Suitable extraction techniques are known. Following extraction, the particles may be ground by conventional means to reduce their size to less than 1 micron, optionally the particles are then screened to obtain a population of particles having a size range for encapsulation, or micronized to produce nanoparticles of suitable size, typically from about 1 to about 1000 nm in diameter.

In some embodiments, the personalizing substance comprises particles of a metal or ceramic object having meaning to a person receiving the substance. For example, such metal or ceramic objects can be ground, screened and extracted to remove unwanted components, encapsulated, and incorporated into an article of jewelry.

In some embodiments, the personalizing substance includes extracts of wooden items that have personal meaning to the individual. For example, in some embodiments cellulose is extracted from the wood item and encapsulated for delivery to the individual.

The personalizing substance may be added as a solid or in the form of a liquid, such as in the form of an emulsion, to the microparticle forming material. Following encapsulation, the personalizing substance is in the form of small particles, typically nanoparticles, in the microparticle. Generally, the personalizing substance is in the core of the microparticles and is surrounded by the hydrophobic, non-erodible polymeric matrix, i.e. the shell. The encapsulated personalizing substance has a size smaller than the resulting microparticles, and is typically smaller than 1 micron in diameter (or in its largest dimension for non-spherical particles).

Types of DNA Molecules in Personalizing Substances

The personalizing substances are intended to remain inert and unreactive after being integrated into the article of jewelry.

According to some embodiments, the personalizing substance does not comprise a vector. As used herein the term “vector” refers to a DNA molecule used in biotechnology for storage, propagation, delivery or integration of recombinant DNA. Examples of vectors include plasmid backbones, viral vectors, bacmids, cosmids, and artificial chromosomes.

Generally, the vector itself is a DNA sequence that consists of an insert (transgene, or recombinant DNA) and a larger sequence that serves as the “backbone” of the vector. The purpose of a vector is to transfer the insert to another cell, where it may be isolated, multiplied, or expressed. In some embodiments, the personalizing substance does not comprise DNA that is used to transfer a DNA sequence into a cell. In some embodiments, the personalizing substance does not comprise DNA used for the purpose of multiplying or expressing the genetic information contained within it.

Optional Components

1. Personal Identification Characteristics

Optionally, the compositions include one or more personal identification characteristics. The one or more personal identification characteristics contain unique information which can be used to verify that the personalizing substance was obtained from a particular source, e.g., human, non-human animal, or plant. A verification step may be made prior to or subsequent to encapsulation.

Exemplary personal identification characteristics for DNA include, but are not limited to, microsatellite markers such as short tandem repeats (STRs) and Simple Sequence Repeat (SSR) markers, single nucleotide polymorphisms (SNPs), and epigenetic markers, such as methylated DNA patterns. Any DNA sequence that is unique to the source organism may be used as a personal identification characteristic. For example the DNA sequence unique to the source organism may be identified by sequencing the entire sequence of the DNA isolated from the source organism, or a portion thereof, using sequencing methods known in the art such as Sanger sequencing or next generation sequencing, e.g. Illumina sequencing. DNA sequencing methods are well known in the art and are described, for example, in Sambrook, et al., Molecular Cloning. (4th ed.). Cold Spring Harbor, N.Y.: Cold Spring Harbor Laboratory.

a. Polymorphic Genetic Markers

DNA generally includes one or more polymorphic genetic markers. Polymorphic genetic markers are highly variable regions of the genome which have contributed to the development of a variety of applications such as forensic DNA analysis and paternity testing that are used to unambiguously identify individuals.

The identification of many polymorphic genetic markers has occurred over the last thirty years. For example, polymorphic genetic markers known as variable number of tandem repeats (VNTRs) are abundant and highly polymorphic regions of DNA containing nearly identical sequences, 14 to 80 bases in length, repeated in tandem. See Jeffreys et al., 1985, Nature 314: 67-73; Wyman et al., 1980, PNAS 77: 6754-6758; and Nakamura et al., 1987, Science 235: 1616-1622. The variation in these markers between individuals makes them useful for identifying particular individuals. VNTRs may be detected from small amounts of DNA using polymerase chain reaction (PCR). See Kasai et al., 1990, Journal of Forensic Sciences 35(5): 1196-1200. Size differences in the amplified PCR products are detected on agarose or polyacrylamide gels. However, the finite number of VNTRs limits the widespread applicability of this method, which in turn led to the identification of short tandem repeats (STR).

b. Short Tandem Repeats (STR)

STRs can be amplified by a polymerase chain reaction, and are highly abundant and polymorphic (variable from individual to individual). STRs can contain tandem repeat sequences that differ by two (dinucleotide), three (trinucleotide), four (tetranucleotide) or five (pentanucleotide) base pairs. It is estimated that there are approximately 50,000 to 100,000 dinucleotide repeats in the human genome. Trinucleotide and tetranucleotide repeats are less common; the human genome is estimated to contain 10,000 of each type of repeat. See Tautz et al, 1989, Nuc. Acids Res. 17: 6464-6471; and Hamada et al., 1982, PNAS 79: 6465-6469. The use of tetranucleotide and pentanucleotide STRs allows better discrimination of differences between individual subjects relative to the shorter sequences. See Weber et al., 1989, Am J Hum Genet 44: 388-396.

The personalizing substance may contain a human DNA sequence selected from the group consisting of a dinucleotide STR, a trinucleotide STR, a tetranucleotide STR and a pentanucleotide STR.

Because the size of PCR products from human tetranucleotide repeat regions typically varies between individuals, tetranucleotide repeats are a preferred personal identification molecule for use as a personalizing substance. For example, PCR products of two different sizes are observed based on the inheritance for each individual of one copy of the polymorphic marker from each parent. Each inherited copy contains a variable number of tetranucleotide repeats. Thus, two unrelated individuals likely will produce different sized PCR products from the same tetranucleotide polymorphic marker. As a greater number of different tetranucleotide repeat regions are compared between individuals, the probability of those individuals sharing the identical pattern of PCR products decreases.

c. Single Nucleotide Polymorphisms (SNPs)

Single nucleotide polymorphism is a DNA sequence variation occurring commonly within a population (e.g. 1%) in which a single nucleotide—A, T, C or G—in the genome (or other shared sequence) differs between members of a biological species or paired chromosomes. For example, two sequenced DNA fragments from different individuals, AAGCCTA to AAGCTTA, contain a difference in a single nucleotide.

SNPs may fall within coding sequences of genes, non-coding regions of genes, or in the intergenic regions (regions between genes). SNPs within a coding sequence do not necessarily change the amino acid sequence of the protein that is produced, due to degeneracy of the genetic code.

SNPs in the coding region are of two types, synonymous and nonsynonymous SNPs. Synonymous SNPs do not affect the protein sequence while nonsynonymous SNPs change the amino acid sequence of protein. The nonsynonymous SNPs are of two types: missense and nonsense.

SNPs that are not in protein-coding regions may still affect gene splicing, transcription factor binding, messenger RNA degradation, or the sequence of non-coding RNA. Gene expression affected by this type of SNP is referred to as an eSNP (expression SNP) and may be upstream or downstream from the gene.

SNPs without an observable impact on the phenotype (so called silent mutations) are still useful as genetic markers in genome-wide association studies, because of their quantity and the stable inheritance over generations.

2. Nanoparticles

Optionally, the personalizing substance(s) can be formed into or encapsulated in nanoparticles prior to encapsulation in the polymeric microparticles.

Any of the aforementioned personalizing substances may be micronized to produce nanoparticles of suitable size.

In some embodiments the nanoparticle comprises or consists of DNA from a human or from a companion animal. The DNA may be precipitated by calcium phosphate. In other embodiments, the nanoparticle comprises, consists of, or is derived from non-DNA personalizing substance, such as sand, soil, metal, water, sea water, holy water, synthetic or biological polymers, cremated ash, or ceramics. In certain embodiments the nanoparticles are formed by micronizing the personalizing substance to reduce its size, in preparation for microencapsulation.

The diameter of the nanoparticle may be, for example, about 1000, 900, 800, 700, 600, 500, 400, 300, 200, 100, 90, 80, 70, 60, 50, 40, 30 or 20 nanometers (nm). In certain embodiments, the diameter of the nanoparticle is less than about 1000, 900, 800, 700, 600, 500, 400, 300, 200, 100, 90, 80, 70, 60, 50, 40, or 30 nanometers (nm). Any of these values may be used to define a range for the diameter of the nanoparticle. For example, the diameter of the nanoparticle may be from about 20 nm to about 1000 nm or from about 20 nm to about 100 nm. The nanoparticles as described above can be place in a container for incorporation into jewelry. The container can be made from a metal or from a mineral such as quartz. According to some embodiments, the container is a quartz tube. The nanoparticles can also be dispersed in a polymer that can be made into an article of jewelry or into a component of an article of jewelry.

2. Polymeric Microparticles

The personalizing substance can be encapsulated in a polymeric microparticle. The core of the microparticle may contain the personalizing substance, which is surrounded by a polymeric matrix that forms the outer shell of the microparticle.

Optionally, the personalizing substance is formed into nanoparticles, which are encapsulated in the polymeric microparticle. In some embodiments, the personalizing substance is a DNA nanoparticle which is prepared by calcium phosphate precipitation. The calcium phosphate precipitated DNA nanoparticle may be encapsulated in a polymeric microparticle without dissolving the DNA in a solvent.

In some embodiments, the microparticle comprises both a personalizing substance and a pigment or dye. Pigment or dye particles in the polymeric microparticles are generally smaller than 100 nm and preferably smaller than 20 nm. In some embodiments, the microparticle comprising the personalizing substance does not include a pigment or dye.

The polymeric microparticles as described above can be place in a container for incorporation into jewelry. The container can be made from a metal or from a mineral such as quartz. According to some embodiments, the container is a quartz tube. The nanoparticles can also be dispersed in a polymer that can be made into an article of jewelry or into a component of an article of jewelry.

A. Polymers

Any polymer that forms a protective layer may be used to form the microparticles. According to some embodiments, the polymer is unreactive to the metal using to manufacture the article. Preferably the composition and molecular weight of the polymers that form the microparticles are such that the glass transition temperature of the polymers is greater than or equal to 60° C. or the melting point of the polymers is greater than or equal to 50° C. In certain embodiments, the glass transition temperature of the polymers is greater than or equal to about 60, 61, 62, 63, 64, 65, 66, 67, 68, 69, 70, 75, or 80° C. In certain embodiments, the melting point of the polymers is greater than or equal to about 50, 51, 52, 53, 54, 55, 56, 57, 58, 59, 60, 65 or 70° C. Preferred polymers with a high glass transition temperature, i.e. a glass transition temperature that is greater than or equal to 60° C., or high melting point, i.e. a melting point that is greater than or equal to 50° C., include, but are not limited to, poly (methyl methacrylate) (PMMA), polystyrene, polyethylene terephthalate, and polycarbonate. In a particular embodiment, the polymer is selected from the group consisting of polyvinyl acetate, polyacrylates, polymethacrylates, and copolymers and blends thereof. In another particular embodiment, the polymer is selected from the group consisting of polyacrylates, polymethacrylates, and copolymers and blends thereof. Preferably, if the microparticle is formed from a copolymer or blend of polymers, the copolymer or blend is formed from polymers with a high glass transition temperature or high melting point, and does not contain any polymer with a low glass transition temperature, i.e. a glass transition temperature lower than 60° C., or a melting point that is lower than 50° C.

Suitable polymers with a glass transition temperature greater than or equal to 60° C. or suitable polymers with a melting point greater than or equal to 50° C. include, but are not limited to, polyacrylates, polymethacrylates, polycarbonates, polypropylenes, polyalkylenes, polyalkylene glycols, polyalkylene oxides, polyalkylene terephthalates, polyvinyl ethers, polyvinyl halides, polysiloxanes, polyurethanes and copolymers thereof, hydroxyalkyl celluloses, cellulose ethers, nitro celluloses, methyl cellulose, ethyl cellulose, cellulose acetate, cellulose propionate, cellulose acetate butyrate, cellulose triacetate, cellulose sulphate sodium salt, poly(methyl methacrylate), poly(ethylmethacrylate), poly(butylmethacrylate), poly(isobutylmethacrylate), poly(hexylmethacrylate), poly(isodecylmethacrylate), poly(lauryl methacrylate), poly(phenylmethacrylate), poly(methyl acrylate), poly(isopropyl acrylate), poly(isobutylacrylate), poly(octadecyl acrylate), polyethylene, poly(ethylene terephthalatepoly(vinyl acetate), and poly vinyl chloride polystyrene, and mixtures, copolymers, and blends thereof.

Preferred polymers include polyacrylates and polymethacrylates.

In certain embodiments, the polymethacrylate is poly(methyl methacrylate) (PMMA). Medical grade PMMA (MW=35 kDa; residual MMA monomer<0.1%) is commercially available from Vista Optics Ltd. (Widnes, UK).

B. Shapes and Sizes

The microparticles can have any shape. Typically the microparticles are spherical. Other suitable shapes include, but are not limited to, flakes, triangles, ovals, rods, polygons, needles, tubes, cubes and cuboid structures.

In certain embodiments, the microparticles have a diameter of less than 10, 9, 8, 7, 6, 5, 4, 3, 2, 1, 0.9, 0.8, 0.7, 0.6, 0.5, 0.4, 0.3, 0.2 or 0.1 micron(s). Any of these values may be used to define a range for the diameter of the microparticle. For example the diameter of the microparticle may be from about 0.1 to about 10 microns, from about 0.1 to about 1 micron, or from about 0.1 to about 2 microns. Typically, the microparticle diameter is less than 5 microns.

In other embodiments, larger microparticles or particles may be used. For example the microparticles may have a diameter of ranging from 10 microns to 1000 microns.

C. Loading of Encapsulated Personalizing Substance in Microparticles

Typically, the concentration of a personalizing substance encapsulated in a microparticle is presented as percent loading. Because values for the percent loading are dependent on the weights of the personalizing substances, percent loading values for the different personalizing substances may vary significantly. Therefore, different ranges for the percent loading for different personalizing substances are contemplated.

In some embodiments, low concentrations (e.g., up to 0.1% w/w or lower) of the personalizing substance in the microparticles are required to prevent leaching of the personalizing substance from the microparticle.

In some embodiments, such as when the encapsulating material is DNA, only a small sample is provided for encapsulation. In these embodiments, the microparticles typically contain low concentrations of DNA. However, if a large amount of the encapsulating material is provided, the loading of the encapsulating material in the microparticle can be higher as long as the resulting microparticles do not allow DNA to be released.

In some embodiments, the microparticle comprises about 0.00001, 0.00005, 0.0001, 0.0005, 0.001, 0.005, 0.01, 0.02, 0.03, 0.04, 0.05, 0.06, 0.07, 0.08, 0.09, 0.1, 0.5, 1, 2, 3, 4, 5, 6, 7, 8, 9 or 10% weight of the encapsulating material/weight of the microparticle (w/w). In some embodiments, the microparticles comprise less than about 0.00001, 0.00005, 0.0001, 0.0005, 0.001, 0.005, 0.01, 0.02, 0.03, 0.04, 0.05, 0.06, 0.07, 0.08, 0.09, 0.1, 0.5, 1, 2, 3, 4, 5, 6, 7, 8, 9 or 10% weight of the encapsulating material/weight of the microparticle (w/w). Any of these values may be used to define a range for the concentration of the encapsulating material in the microparticle. For example, the microparticles may contain encapsulating material in an amount ranging from about 0.00001 to about 10% w/w or from about 0.001 to about 2% w/w. In some embodiments, the amount of encapsulating material in the microparticles is less than about 0.1% w/w.

According to some embodiments, the amount of encapsulating material in the microparticles can be up to 10% w/w, for example 1 to 10% w/w or 5 to 10% w/w when the microparticles are used in a polymer solution casting method as described below. Higher amounts of encapsulating material can be used (e.g., up to 90% w/w or up to 30% w/w) depending on the personalizing substance, the polymer used and the durability of the cast polymer solution required for a given application. Higher amounts of encapsulating material may be used where the durability of the cast polymer solution is of less importance (e.g., where the cast polymer is protected or subject to less wear).

1. Percent Loading of DNA

Typically, percent loading for DNA in the microparticles ranges from 0.000001% to 0.1% weight of DNA to the total weight of the microparticles (% w/w). In preferred embodiments, the amount of DNA in the microparticles is less than 0.01% (w/w) DNA, more preferably the amount of DNA in the microparticles ranges from 0.001% to 0.00001% (w/w). These loading ranges are generally applicable to single-walled microparticles.

However, for embodiments, in which the microparticles are double walled microparticles, higher loadings of DNA may be used. It is expected that the structure of the double-walled microparticles protects the DNA from leaching out of the microparticles. In these embodiments, the amount of DNA in the microparticles may range from 0.000001% to about 5% weight of DNA to the total weight of the microparticles (% w/w), optionally from about 1%-5% (w/w).

2. Percent Loading of Other Personalizing Substances

Typically, the percent loading of personalizing substances other than DNA is higher than the loadings of DNA in the microparticles. For example, the amount of the personalizing substance in the microparticles may range from about 0.001 to about 10% w/w or from about 0.001 to about 2% w/w. Optionally, the amount of the personalizing substance in the microparticle is less than about 0.001, 0.005, 0.01, 0.02, 0.03, 0.04, 0.05, 0.06, 0.07, 0.08, 0.09, 0.1, 0.5, 1, 2, 3, 4, 5, 6, 7, 8, 9 or 10% w/w. Any of these values may be used to define a range for the concentration of the substance in the microparticle. For example, the amount of the personalizing substance in the microparticle may range from about 0.001 to about 10% w/w or from about 0.001 to about 2% w/w. In a particular embodiment, the microparticle comprises less than about 0.1% w/w of the personalizing substance other than DNA.

4. Exemplary Composition Containing DNA

In certain embodiments, the personalizing substance to be delivered to the individual, contains DNA from a human, a non-human animal (e.g. a pet), or a plant.

In a particular embodiment, the DNA is from a human. No two people have the exact same sequence of DNA in their cells. The differences in the DNA in individual humans gives rise to the unique DNA profiles that can be used to distinguish individuals. In addition, the unique DNA profile of each individual provides a means for verifying that the personalizing substance is from a particular individual.

The DNA may be coding or non-coding genomic DNA, coding or non-coding mitochondrial DNA or complementary DNA (cDNA). cDNA is synthesized from RNA using reverse transcriptase. The genomic DNA, mitochondrial DNA, and RNA for synthesis of cDNA may be isolated from any organism, including but not limited to humans, animals, and plants. In some embodiments, the DNA is isolated from a single organism, for example, a human. In other embodiments, the DNA is isolated from two or more organisms, for example, two or more humans. Methods of isolating genomic DNA, mitochondrial DNA and RNA, and methods of cDNA synthesis are well known in the art and are described, for example, in Sambrook, et al., Molecular Cloning. (4th ed.). Cold Spring Harbor, N.Y.: Cold Spring Harbor Laboratory.

D. DNA Isolation and Amplification

In some embodiments, the DNA contained in the personalizing substance is isolated directly from an organism, such as genomic DNA or mitochondrial DNA. In other embodiments, the DNA contained in the personalizing substance is amplified from a sample collected from the organism, for example by polymerase chain reaction (PCR). Multiple DNA segments for tetranucleotide PCR amplification typically may be amplified in a single tube. Multiple amplification of several DNA regions is known in the art as multiplex PCR. The multiple PCR products are separated as known in the art, for example, by electrophoresis, and an instrument reads the electrophoresis gel or image to automatically analyze the sizes of the PCR products. In some embodiments, the DNA contained in the personalizing substance is cDNA reverse transcribed from RNA isolated from the organism, as mentioned above.

The DNA may be sequenced so that verification steps described below may be performed. (Sambrook, et al., Molecular Cloning. (4th ed.). Cold Spring Harbor, N.Y.: Cold Spring Harbor Laboratory).

Preparation of DNA samples for use as a personalizing substance may proceed as follows, although other methods of preparing analogous DNA samples are known to the skilled artisan. One preferred method includes the following general steps:

A sample for preparation of the DNA contained in the personalizing substance is collected from a sample of cheek swab, skin, hair, saliva, or blood or other tissue from an organism as is known in the art. A cheek swab sample is preferred. Protocols for collecting and handling the sample are known in the art.

For example, a DNA isolation kit suitable for isolating genomic DNA from buccal cells, may be used to isolate DNA from the cheek swab. These kits are commercially available and usually generate 0.5 -2 micrograms of total DNA. Desirable genomic regions containing polymorphic genetic markers (such as STRs and SNPs) of the isolated DNA are then amplified via PCR to generate micrograms, typically from 1 to 10 micrograms, of DNA to be used as a personalizing substance. The amplified DNA may be sequenced so that verification steps described below may be performed. This amplified DNA is the personalizing substance that is encapsulated into microparticles.

Optionally, the encapsulation of personalizing DNA molecule may include a control DNA molecule of a known sequence that is included at the same amount as the personalizing DNA molecule. The control DNA may be used for testing to determine whether any of encapsulated DNA is released, such as via the in vitro method described above.

Alternatively, or optionally, the personalizing DNA may be partially or fully labeled with fluorophores, such as Alexa Fluor® dyes (Molecular Probes, Inc.). The labeled DNA may be used to confirm that the DNA was successfully encapsulated, such as with flow cytometry of the encapsulated particles.

Transmission electron microscopy (TEM) may be used to verify encapsulation of the amplified DNA.

In some embodiments, genomic DNA, mitochondrial DNA, and/or RNA is isolated from the sample using methods known in the art, such as those described in Sambrook et al. (cited above). The concentration and integrity of the extracted DNA or RNA may be determined, for example, to inform the decision to proceed with PCR or reverse transcription or to obtain another sample.

In some embodiments, the DNA contained in the personalizing substance may be generated by PCR. For example, DNA comprising STRs may be amplified by PCR using primers that amplify three to five tetranucleotide repeat segments of the genomic DNA sample, optionally incorporating a detectable label, such as a radioactive or fluorescent label, as is known in the art. PCR primers for amplifying the DNA may be obtained from a commercial source or may be synthesized using methods known in the art. Software for design of PCR primers is well known in the art.

Examples of preferred STRs that may be amplified by PCR are set forth in Table 2 below. The skilled artisan will appreciate that additional suitable tetranucleotide and pentanucleotide repeats may also be amplified. One of the preferred qualities of suitable tetranucleotide DNA repeats is high heterozygosity (variability between individuals) in the subject population. Another preferred quality of suitable tetranucleotide DNA repeats is that they do not encode a biologically active product, for example, a protein, tRNA, rRNA, miRNA, or siRNA. A further preferred quality of suitable tetranucleotide DNA repeats is that they do not induce an immune response and produce no therapeutic action in the recipient.

TABLE 2
Preferred Repeats in DNA for amplification

| Human | Allele Distribution | Number of |
|---|---|---|
| Marker | (bp) | Repeats |
| D3S1358 | 98 to 146 | 8 to 20 |
| D5S818 | 133 to 169 | 7 to 16 |
| D7S820 | 215 to 247 | 6 to 14 |
| D8S1179 | 163 to 213 | 7 to 19 |
| D13S317 | 161 to 205 | 5 to 16 |
| D16S539 | 133 to 173 | 5 to 15 |
| D21S11 | 201 to 257 | 24 to 38 |
| D8S1106 | 109 to 133 | 7 to 13 |
| D1S518 | 182 to 198 | 13 to 17 |
| D6S1017 | 354 to 374 | 10 to 15 |
| D17S1304 | 197 to 213 | 10 to 14 |
| D4S2408 | 336 to 360 | 13 to 19 |
| D5S1467 | 173 to 189 | 8 to 12 |
| D19S245 | 225 to 249 | 16 to 22 |

The resulting PCR products are typically analyzed, for example, by electrophoresis, for the successful generation of tetranucleotide repeats and to confirm that the sample shows relatively unique representation of a DNA sample from an individual.

E. Verification of Amplified DNA

In some embodiments, the DNA is analyzed to confirm that the DNA contained in the personalizing substance was obtained or generated from the desired source organism. For example, for DNA comprising STRs, the pattern of PCR products in the DNA contained in the personalizing substance may be compared to a control sample obtained from the source organism. The DNA contained in the personalizing substance may also be analyzed by DNA sequencing, for example cDNA sequencing or whole genome sequencing, to confirm that the DNA contained in the personalizing substance is from the desired source organism.

The sequencing of the DNA may be performed using methods known in the art. These include, but are not limited to basic sequencing methods, such as Sanger's method, Maxam-Gilbert sequencing and chain termination methods (França et al., Quarterly Review of Biophysics, 35(2):169-200, 2002), advanced methods and de novo sequencing, such as shotgun sequencing and bridge PCR (Braslavky et al., Proc. Natl. Acad. Sci, 100(7):3960-3964, 2003), or next-generation methods. Next-generation sequencing applies to genome sequencing, genome resequencing, transcriptome profiling (RNA-Seq), DNA-protein interactions (ChIP-sequencing), and epigenome characterization (de Magalhães et al., Ageing Res Rev. 9(3)315-323, 2010; Liu et al., Journal of Biomedicine and Biotechnology, 2012:1-11, article ID 251364, 2012; and Hall, The Journal of Experimental Biology, 209:1518-1525, 2007). Resequencing is necessary, because the genome of a single individual of a species will not indicate all of the genome variations among other individuals of the same species.

Next Generation sequencing encompasses a number of methods, including, but not limited to single-molecule real-time sequencing, massively parallel signature sequencing, (MPSS), Polony sequencing, 454 pyrosequencing, ion torrent semiconductor sequencing, DNA nanoball sequencing, heliscope single molecule sequencing, sequencing by ligation (SOLiD sequencing) and single molecule real time sequencing (SMRT). These methods are detailed and compared in Liu et al., Journal of Biomedicine and Biotechnology, 2012:1-11, article ID 251364, 2012, and Hall, The Journal of Experimental Biology, 209:1518-1525, 2007.

In some embodiments, the DNA contained in the personalizing substance is analyzed before the personalizing substance is integrated into the article of jewelry. In other embodiments, the DNA contained in the personalizing substance is analyzed after the personalizing substance is integrated into the article of jewelry.

The DNA may be purified to obtain pharmaceutical/biologics grade DNA suitably free of contaminants.

II. Methods of Making the Compositions

The microparticles may be made using a variety of known microencapsulation methods, such as solvent evaporation, multi-walled (or double walled) microencapsulation, coacervation, and melt processing.

Any of the non-bioerodible, hydrophobic polymers discussed above may be used to form the polymeric microparticles.

1. Solvents

Solvents that may be used in forming the microparticles include organic solvents such as methylene chloride, which leave low levels of residue that are generally accepted as safe. Suitable water-insoluble solvents include methylene chloride, chloroform, dicholorethane, ethyl acetate and cyclohexane. Additional solvents include, but are not limited to, alcohols such as methanol (methyl alcohol), ethanol, (ethyl alcohol), 1-propanol (n-propyl alcohol), 2-propanol (isopropyl alcohol), 1-butanol (n-butyl alcohol), 2-butanol (sec-butyl alcohol), 2-methyl-1-propanol (isobutyl alcohol), 2-methyl-2-propanol (t-butyl alcohol), 1-pentanol (n-pentyl alcohol), 3-methyl-1-butanol (isopentyl alcohol), 2,2-dimethyl-l-propanol (neopentyl alcohol), cyclopentanol (cyclopentyl alcohol), 1-hexanol (n-hexanol), cyclohexanol (cyclohexyl alcohol), 1-heptanol (n-heptyl alcohol), 1-octanol (n-octyl alcohol), 1-nonanol (n-nonyl alcohol), 1-decanol (n-decyl alcohol), 2-propen-1-ol (allyl alcohol), phenylmethanol (benzyl alcohol), diphenylmethanol (diphenylcarbinol), triphenylmethanol (triphenylcarbinol), glycerin, phenol, 2-methoxyethanol, 2-ethoxyethanol, 3-ethoxy-1,2-propanediol, Di(ethylene glycol)methyl ether, 1,2-propanediol, 1,3-propanediol, 1,3-butanediol, 2,3-butanediol, 1,4-butanediol, 1,2-pentanediol, 1,3-pentanediol, 1,4-pentanediol, 1,5-pentanediol, 2,3-pentanediol, 2,4-pentanediol, 2,5-pentanediol, 3,4-pentanediol, 3,5-pentanediol, and combinations thereof. A preferred alcohol is isopropanol.

Materials that may be used to formulate a coacervate system comprise anionic, cationic, amphoteric, and non-ionic surfactants. Anionic surfactants include di-(2 ethylhexyl)sodium sulfosuccinate; non-ionic surfactants include the fatty acids and the esters thereof surfactants in the amphoteric group include (1) substances classified as simple, conjugated and derived proteins such as the albumins, gelatins, and glycoproteins, and (2) substances contained within the phospholipid classification, for example lecithin. The amine salts and the quaternary ammonium salts within the cationic group also comprise useful surfactants. Other surfactant compounds useful to form coacervates include polysaccharides and their derivatives, the mucopolysaccharides and the polysorbates and their derivatives. Synthetic polymers that may be used as surfactants include compositions such as polyethylene glycol and polypropylene glycol. Further examples of suitable compounds that may be utilized to prepare coacervate systems include glycoproteins, glycolipids, galactose, gelatins, modified fluid gelatins and galacturonic acid.

3. Surfactants

Hydrophobic surfactants such as fatty acids and cholesterol may be added during preparation of the microparticles to improve the resulting distribution of hydrophobic personalizing substances in hydrophobic polymeric microparticles. Examples of suitable fatty acids include butyric acid, valeric acid, caproic acid, enanthic acid, caprylic acid, pelargonic acid, caprylic acid, undecylic acid, lauric acid, tridecylic acid, myristic acid, pentadecylic acid, palmitic acid, heptadecylic acid, stearic acid, nonadecanoic acid, arachic acid, isocrotonic acid, undecylenic acid, oleic acid, elaidic acid, sorbic acid, linoleic acid, linolenic acid and arachidonic acid.

Hydrophilic surfactants such as TWEEN® 20 and polyvinyl alcohol (PVA) improve distribution of hydrophilic dye in the polymers. Amphiphilic surfactants are preferred if the dye is hydrophilic and the polymer is hydrophobic.

Surfactant such as a fatty acid or a pharmacologically acceptable salt thereof is typically added in a ratio of from 0.2 to 1 part by weight of the fatty acid or salt thereof to 1 part by weight of the dye.

4. Micronizing and Nanoparticle Formation

Methods for micronizing the personalizing substance for production of nanoparticles, if needed, include, for example, sonication and/or production of shear forces, and rotor stator mixing or milling with a concentric shaft, at a speed between, for example, 5,000 RPM and 25,000 RPM.

In some embodiments where DNA is the personalizing substance, the DNA may be prepared by precipitation using standard techniques, such as ethanol or isopropanol precipitation, or salt precipitation. In some embodiments, the DNA is micronized by precipitation with calcium phosphate, and the precipitate is not dissolved but instead incorporated directly as nanoparticles into the microparticle. In some embodiments, the DNA is encapsulated as an emulsion in water which is later removed after the encapsulation process to produce a small solid particle of DNA. The DNA may also be bound to a solid nanoparticle such as silicon dioxide or gold, or crosslinked together to form aggregates.

Methods of encapsulating DNA in nanoparticles are described in the art. See, for example, U.S. Patent Application Ser. No. 2009/0311295, and van de Berg et al., 2010, Journal of Controlled Release 141: 234-240.

5. Distribution of Nanoparticles within Microparticles

Preferably the nanoparticle containing the personalizing substance are uniformly distributed within the polymer microparticle and at a low loading level to avoid any leaching of the encapsulated personalizing substance. This is particularly desirable when the encapsulating material is or contains DNA.

The problem with most methods of manufacture of microparticles is that while the nanoparticles are dispersed initially following addition to polymer solution, the nanoparticles rapidly settle towards the bottom. Then when solvent is removed, the nanoparticles are present more preferentially in one part of the polymer than another. It is difficult to keep the nanoparticles dispersed while at the same time removing the polymer solvent to form the microparticles. Therefore, methods have been developed wherein the nanoparticles are dispersed in the polymer solution so that the solution is “stabilized” so that the nanoparticles stay uniformly distributed within the polymer for a period of time sufficient to form the microparticles. This time may be as short as ten minutes or as long as a few hours. The amount of time that the nanoparticle will remain suspended in the polymer depends on the size and composition of the nanoparticle.

Stability is a function of the selection of the polymer, the solvent composition as well as the method of dispersion and the density of the encapsulated material. For example, the concentration of the organic polymeric solution must be adjusted to keep the nanoparticles dispersed and prevent settling of the nanoparticles during the process of encapsulation. In a method theoretically (if not mechanistically) analogous to beating egg whites, the polymer solution is sonicated or otherwise subjected to shear forces, using an open blade mixer or rotor stator at 5000-25,000 RPM, or milled using a concentric shaft, until stable. Alternatively or in addition, the solvent and surfactant, if present, can be used to alter the surface properties of the nanoparticles so that they remain suspended in the polymer solution. The solvent is then removed to form the microparticles having a uniform dispersion of nanoparticles within the polymer.

6. Methods of Making Microparticles

There are several processes whereby microparticles can be made, including, for example, multi-walled microencapsulation, hot melt encapsulation, phase separation encapsulation, spontaneous emulsion, solvent evaporation microencapsulation, solvent removal microencapsulation, and coacervation. These methods are known in the art. Detailed descriptions of the methods are discussed in Mathiowitz et al., “Microencapsulation”, in Encyclopedia of Controlled Drug Delivery, vol. 2, pp. 495-546, 1999, John Wiley & Sons, Inc. New York, N.Y., and are concisely presented below. A preferred method is solvent evaporation microencapsulation (specifically high oil to aqueous phase ratio to achieve small particles with addition of surfactant such as oleic acid to improve dispersion of the personalized fragment in the polymeric phase phase). For solvent evaporation, the minimum concentration is 0.1% w/v (polyvinyl alcohol to water). Another preferred method includes addition of the nanoparticles into the polymer liquefied by melting to ensure uniform distribution.

The dispersion of the nanoparticles within the polymer matrix can be enhanced by varying: (1) the solvent or combination of solvents used to solvate the polymer; (2) the ratio of the polymer to the solvent; (3) the size of the nanoparticle to be encapsulated; and (4) the percentage of the nanoparticle relative to the polymer (i.e. nanoparticle loading). The dispersion of the nanoparticles within the polymer matrix may also be enhanced by using surfactants.

In certain embodiments, the personalizing substance is analyzed during the process of preparing the microparticles, e.g. after micronization and/or after encapsulation, to confirm the identity of the personalizing substance. Generally, the microparticles are prepared in small batches.

A. Hot Melt Microencapsulation

In hot melt microencapsulation, the personalizing substance (optionally in the form of nanoparticles) to be encapsulated is added to molten polymer. This mixture is suspended as molten droplets in a nonsolvent for the polymer (often oil-based) which has been heated to approximately 10° C. above the melting point of the polymer. The emulsion is maintained through vigorous stirring while the nonsolvent bath is quickly cooled below the glass transition of the polymer, causing the molten droplets to solidify and entrap the core material.

B. Phase Separation Microencapsulation

In phase separation microencapsulation the personalizing substance (optionally in the form of nanoparticles) to be encapsulated is dispersed in a polymer solution with stirring. While continually stirring to uniformly suspend the material, a nonsolvent for the polymer is slowly added to the solution to decrease the polymer's solubility. Depending on the solubility of the polymer in the solvent and nonsolvent, the polymer either precipitates or phase separates into a polymer rich and a polymer poor phase. Under proper conditions, the polymer in the polymer rich phase will migrate to the interface with the continuous phase, encapsulating the personalizing substance (optionally in the form of nanoparticles) in a droplet with an outer polymer shell.

C. Spontaneous Emulsification

Spontaneous emulsification involves solidifying emulsified liquid polymer droplets by changing temperature, evaporating solvent, or adding chemical cross-linking agents. The physical and chemical properties of the encapsulant, and the personalizing substance to be encapsulated, dictates the suitable methods of encapsulation. Factors such as hydrophobicity, molecular weight, chemical stability, and thermal stability affect encapsulation.

D. Melt-Solvent Evaporation Method

In the melt-solvent evaporation method, the polymer is heated to a point of sufficient fluidity to allow ease of manipulation (for example, stirring with a spatula). The temperature required to do this is dependent on the intrinsic properties of the polymer. For example, for crystalline polymers, the temperature will be above the melting point of the polymer. After reaching the desired temperature, the personalizing substance (optionally in the form of nanoparticles) is added to the molten polymer and physically mixed while maintaining the temperature. The molten polymer and personalizing substance are mixed until the mixture reaches the maximum level of homogeneity for that particular system. The mixture is allowed to cool to room temperature and harden. This technique results in dispersion of the personalizing substance in the polymer.

High shear turbines may be used to stir the dispersion, complemented by gradual addition of the nanoparticle into the polymer solution until the desired loading is achieved. Alternatively the density of the polymer solution may be adjusted to prevent settling of the nanoparticle during stirring.

E. Solvent Evaporation Microencapsulation

In solvent evaporation microencapsulation, the polymer is typically dissolved in a water immiscible organic solvent and the personalizing substance (optionally in the form of nanoparticles) to be encapsulated is added to the polymer solution as a dispersion, suspension or emulsion in an organic solvent An emulsion (i.e. a second emulsion if the encapsulating material is added as an emulsion) is formed by adding this dispersion, suspension or emulsion to a beaker and vigorously stirring the system. Any suitable surface active agent may be used to stabilize the emulsion. Typical surface active agents include, but are not limited to polyethylene glycol or polyvinyl alcohol (PVA)). The organic solvent is evaporated while continuing to stir. Evaporation results in precipitation of the polymer, forming solid microcapsules containing core encapsulated material, where the encapsulated material is in the form of an emulsion or a solid.

The solvent evaporation process can be used to entrap a liquid core material in a polymer or in copolymer microcapsules, however the liquid is removed by conventional methods after the polymer has encapsulated the substance.

The solvent evaporation process is the preferred process for encapsulating DNA.

F. Solvent Removal Microencapsulation

In solvent removal microencapsulation, the polymer is typically dissolved in an oil miscible organic solvent and the personalizing substance (optionally in the form of nanoparticles) to be encapsulated is added to the polymer solution as a suspension or solution in organic solvent. Surface active agents can be added to improve the dispersion of the material to be encapsulated. An emulsion is formed by adding this suspension or solution to vigorously stirring oil, in which the oil is a nonsolvent for the polymer and the polymer/solvent solution is immiscible in the oil. The organic solvent is removed by diffusion into the oil phase while continuing to stir. Solvent removal results in precipitation of the polymer, forming solid microcapsules containing core material.

G. Coacervation

Encapsulation procedures for various substances using coacervation techniques have been described in the art, for example, in GB-B-929 406; GB-B-929 401; U.S. Pat. Nos. 3,266,987; 4,794,000 and 4,460,563. Coacervation is a process involving separation of colloidal solutions into two or more immiscible liquid layers (Dowben, General Physiology, Harper & Row, New York, 1969, pp. 142-143.). Through the process of coacervation, compositions comprised of two or more phases known as coacervates may be produced. The ingredients that comprise the two phase coacervate system are present in both phases; however, the colloid rich phase has a greater concentration of the components than the colloid poor phase.

In the coacervation process, the polymer or copolymer is dissolved in a miscible mixture of solvent and nonsolvent, at a nonsolvent concentration which is immediately below the concentration which would produce phase separation (i.e., cloud point). The liquid core material is added to the solution while agitating to form an emulsion and disperse the material as droplets. Solvent and nonsolvent are vaporized, with the solvent being vaporized at a faster rate, causing the polymer or copolymer to phase separate and migrate towards the surface of the core material droplets. This phase-separated solution is then transferred into an agitated volume of nonsolvent, causing any remaining dissolved polymer or copolymer to precipitate and extracting any residual solvent from the formed membrane. The result is a microcapsule composed of polymer or copolymer shell with a core of liquid material.

For example, DNA may be dissolved in water and then an emulsion of the dissolved DNA is formed in an organic polymeric solution. This emulsion is then added to aqueous solution and mixed (optionally, for DNA having lengths of less than 2 kilobases (kb) high shear may be used) until the organic solvent evaporates, and then the entire mixture is washed and frozen and lyophilized, resulting in a dry particle of DNA inside the polymer.

The material can be encapsulated using an emulsifier such as Tween 80®, oleic acid, lecithin, Brij® 92, Span® 80, Arlacel® 83, and Span® 85. Alternatively, the material can be encapsulated without the use of an emulsifier.

H. Multi-Walled Microencapsulation

Multiwall polymer microspheres may be prepared by dissolving two polymers in a solvent. A personalizing substance to be incorporated is dispersed in the polymer solution, and the mixture is suspended in a continuous phase. The solvent then is slowly evaporated, creating microspheres with an inner core formed by one polymer and an outer layer of the second polymer. The continuous phase can be either an organic oil, a volatile organic solvent, or an aqueous solution containing a third polymer that is not soluble with the first mixture of polymers and which will cause phase separation of the first two polymers as the mixture is stirred.

Any two or more different non-biodegradable, hydrophobic polymers which are not soluble in each other at a particular concentration as dictated by their phase diagrams may be used. The multilayer microcapsules have uniformly dimensioned layers of polymer and can incorporate a range of substances.

For the preparation of double walled microspheres, each polymer is dissolved in a suitable solvent for that polymer, in separate containers, and mixed with surfactant such as oleic acid; the personalizing substance, optionally in the form of nanoparticles, is added to one of the polymeric solutions. Then the two (or more) polymeric solutions are mixed, and the mixture is then added to a large volume aqueous phase containing a surfactant, such as PVA, to form an emulsion (aqueous solution of water and some surfactant). High shear is applied. The oil to water phase ratio is typically 1:20 to ensure small microparticle sizes in the range of 1-5 microns, or even smaller microparticles, such as in the range of 1 to 2 microns.

Microspheres containing a polymeric core made of a first polymer and a uniform coating of a second polymer, and a substance incorporated into at least one of the polymers, can be made as described in U.S. Pat. No. 4,861,627.

I. Solvent Evaporation is Advantageous for Nanoparticle Microencapsulation

Solvent evaporation microencapsulation can result in the stabilization of the nanoparticle in a polymeric solution for a period of time sufficient for encapsulation of the nanoparticle. In certain embodiments, the nanoparticle is stabilized in the polymeric solution for about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 minutes. In certain embodiments, the nanoparticle is stabilized in the polymeric solution for at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 minutes. In certain embodiments, the nanoparticle is stabilized in the polymeric solution for less than about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 minutes. Any of these values may be used to define a range for the amount of time that the nanoparticle is stabilized in the polymeric solution. For example, the nanoparticle may be stabilized in the polymeric solution for about 10 minutes to about 30 minutes.

Stabilizing a personalizing substance within the dispersed phase (typically a volatile organic solvent) can be useful for most methods of microencapsulation that are dependent on a dispersed phase, including film casting, solvent evaporation, solvent removal, spray drying, phase inversion, and many others.

By stabilizing suspended nanoparticles within the dispersed phase, the nanoparticles remain homogeneously dispersed throughout the polymeric solution as well as the resulting polymer matrix that forms during the process of microencapsulation.

Solvent evaporation microencapsulation has several advantages. For example, solvent evaporation microencapsulation allows for the determination of the best polymer-solvent-nanoparticle mixture that will aid in the formation of a homogeneous suspension that can be used to encapsulate the nanoparticle. Solvent evaporation microencapsulation stabilizes the nanoparticles within the polymeric solution. This stabilization of nanoparticles is an advantage during small scale operation because one will be able to let suspensions of insoluble particles sit for short periods of time, making the process more secure and avoiding mixing between clients. Solvent evaporation microencapsulation allows for the creation of microparticles that have no release of the encapsulated material. Solvent evaporation microencapsulation avoids the problem of “burst effect”, i.e. release of the encapsulated material within 1 hour of administration, which occurs with other encapsulation methods by allowing very low loading of the nanoparticles or personalizing substance and creating microparticles that have minimal pores.

7. Small Batch Preparation

In some embodiments, the compositions are made in small batches. The size of the batches may be limited by the nature and the amount of the personalizing substance, or by the number of end users.

In preferred embodiments, the personalizing substances are encapsulated into polymeric microparticles for personal use by one or few individuals. It is preferred, therefore, to prepare small batches of polymeric microparticles encapsulating the personalizing substance. In some embodiments, the prepared batch size may be as small as for single use by a single individual. In other embodiments, the prepared batch size may be as small as for single use by few, such as no more than two, no more than three, no more than four, no more than five, no more than six, no more than seven, no more than eight, no more than nine, or no more than ten individuals. In other embodiments, the batch size may be as small as for multiple uses by the same individual.

In other embodiments, the size of a small batch preparation may be guided by the amount of the available personalizing substance. For example, if DNA is used as a personalizing substance, the amount of DNA obtained from one individual through a cheek swab may only be small enough to produce a batch for single use by a single recipient. In a preferred embodiment, a single small batch yields a sufficient amount of microparticles encapsulating the personalizing substance for a single use by one end user.

In preferred embodiments, a small batch preparation process yields approximately 1-10 g of microparticles encapsulating the personalizing substance, in dry form, preferably about 1-2 g of microparticles encapsulating the personalizing substance, in dry form. For example, in some embodiments, 0.1, 0. 2, 0.3, 0.4, 0.5, 0.6, 0.7, 0.8, 0.9, 1.0, 1.5, 2.0, 2.5, 3.0, 3.5, 4.0, 4.5, 5.0, 6.0, 7.0, 8.0, 9.0 or 10 grams of the microparticle is prepared. In some embodiments, less than 0.1, 0. 2, 0.3, 0.4, 0.5, 0.6, 0.7, 0.8, 0.9, 1.0, 1.5, 2.0, 2.5, 3.0, 3.5, 4.0, 4.5, 5.0, 6.0, 7.0, 8.0, 9.0 or 10 grams of the microparticle is prepared. Any of these values may be used to define a range of amounts in which the microparticle is prepared. For example, from 0.5 to 5 grams, or from 2 to 5 grams of the microparticle may be prepared. In a particular embodiment, approximately 2 grams of the microparticles is prepared.

Those microcapsules could be further incorporated as filler into a quartz tube or any other container that will be made from metals or additional polymers that will be use as jewelry.

Metallurgical Processes

Various metallurgical processes can be used to manufacture jewelry incorporating a personalizing substance. These metallurgical processes may be divided into three general categories: cold joining techniques, warm molding and bonding techniques and hot techniques such as casting. Cold joining techniques involve no liquid metal and minimum thermal management. Warm molding and bonding techniques involve only small amounts of liquid metal for bonding and sealing and nominal thermal management. Hot metallurgical techniques such as casting involve relatively large amounts of liquid metal and may require thermal management for temperature sensitive personalizing substances.

The cold joining techniques for application to precious metals (Platinum group, Au Ag) are based on application of pressure to create a diffusion bond. Sustained pressure applied to an intimate interface between Pt and Au (for e.g.) will result in plastic deformation and migration by substitutional diffusion of Pt atoms into Au and Au atoms into Pt to create this bond. Diffusion is facilitated by the fact that precious metals (by definition) are not subject to oxidation at ambient temperatures. The surfaces to be joined, however, should be chemically clean to facilitate bonding.

The cold joint diffusion bonding process can be enhanced by vibration and by controlled thermal or electrical pulses. These methods involve pressure as an integral parameter. The techniques include ultrasonic welding, spot welding, seam welding (sequential “stitching” with overlapping spot welds), and friction welding.

Warm molding techniques involve formation of a joint by melting limited volumes of metal. The processes applicable to this disclosure are those in which thermal excursions can be controlled by weld cycle frequency and by power input (i.e., volume of metal changed to the liquid state). Techniques include: LASER welding electron beam welding, and arc welding (Tungsten inert gas, TIG) and 3D printing. Application of these techniques to enclose a sample of DNA (contained in hermetically sealed glass bead, for example) will involve management of heat input to ensure the DNA capsule does not experience excessive temperatures (e.g., in excess of 100° C.).

A powder metallurgical approach is also included in the “warm” category. This involves forming a “cocoon” around the DNA capsule employing cold isostatic pressing (CIP). This process is the first stage in forming PM parts and involves packing alloy or pure metal powder into a mold and pressing it to initiate fusion of the powder particles. A carrier is used to aid this process and control oxidation during a low temperature sintering step. Once successfully contained within this porous metal structure, the DNA sample is then ready for addition of a precious metal skin. The skin can be applied by one of several processes, which include vapor deposition, electroplating and dipping into a bath of liquid metal.

Hot metallurgical techniques can be used with a personalizing substance which can withstand higher temperatures (e.g., temperatures above 100° C.). Success of this method, which would produce rough castings of jewelry pieces encasing the personalizing substance, may include insulation within and around the personalizing substance. Because heat capacity and thermal conductivity of precious metals is high, castings may have to be made in several stages. It may be necessary to determine for each stage the volume of liquid metal that can be cast and “thermally managed.” This can be accomplished through design of an efficient mold for conducting the heat away from the personalizing substance. Each successive stage of the casting will present a different thermal problem, due to the need to account for conduction into the prior solidified metal envelope encasing the DNA module, and conduction into the casting mold.

The following metallurgical processes are well known and are established as industrial manufacturing methods. The techniques outlined in the following paragraphs could be used by themselves or in combination with other processes to fabricate a metallic body to encase a personalizing substance. The metallurgical processes described below could be applied in such a way to protect the personalizing substance from experiencing damaging temperatures or environments during manufacture.

Cold Metallurgical Processes

Cold metallurgical processes which can be used to form a metallic article encasing a personalizing substance such as DNA sample include, but are not limited to, the following.

Cold Welding Processes

Burnishing

This is the age old process of mechanically smearing metal pieces together. An example would be a dentist mechanically working gold foil together to form a dental restoration. Because gold does not oxidize readily it is relatively simple to create adjoining surfaces that are metallurgically bonded.

Co-Extrusion/Drawing

This process creates a metallurgical bond by mechanically joining chemically clean metal surfaces placed under a compressive force as they are pushed or pulled through a die. The process is commonly used to bond different alloys together to form bi-metallic tubes, bars, and wire.

Inertial Welding

This a process in which two parts are bonded together by counter-rotating the components at high speeds and then rapidly pushing them together. The sudden surface-to-surface contact creates a metal bond. The process does generate momentary heat from friction and adiabatic heating.

Cold Spraying Processes

Cold spraying is a high speed spraying process that bonds solid metallic powders onto a substrate. Thermal spray coating, on the other hand, sometimes requires a preheated substrate and relies on the metallic powder or wire to become molten before contact.

Cold Pressing of Powder

This is a process where powder particles are combined by the unidirectional, hydraulic pressing of a loose powder inside of a die. Generally, compacts such as this are stronger if the starting powder is irregularly shaped rather than spherical. Irregularly shaped powder is commonly produced by water atomization rather than gas atomization. A cold pressed powder compact generally does not have 100% density. It would be possible to LASER glaze the surface to keep the compact intact. A LASER glazed semi-porous compact would contain less precious metal and would be more affordable. Powders can also be cold isostatically pressed (CIP). In this process, the loose powder is placed in a flexible container that is evacuated, sealed and then exposed large isostatic pressure.)

Electrolytic Deposition

This process is simply electroplating the precious metal onto a surface from an electrolyte solution. The temperature of the process is normally low (<100° C.). The thickness of the deposited metal is a function of plating parameters.

Explosive Bonding

Parts to be bonded are arranged in such a way that a controlled explosion creates a shock wave, which produces a metallurgical bond.

Amalgamation

This is a room temperature process where metallic powders of specific composition are mixed with a liquid metal, such as mercury, which rapidly diffuses into the powder to create a solid structure of a desired shape. Historically, this technique has been used worldwide to fill dental cavities. During the amalgamation process a minimal amount of heat may be generated during the solution process.

Warm Metallurgical Processes

Warm metallurgical processes which can be used to form a metallic article encasing a DNA sample include but are not limited to the following.

LASER Overlay (LASER Welding)

This is a process where a small LASER beam can apply very high temperatures to a small spot for a short time. The LASER application makes it possible to fusion weld a small area without overheating the substrate that it is working on. LASER welding can be used to weld a seam together without a filler material, but could also be used with a filler material such as metal powder or wire.

Additive Manufacturing/3D Printing/Direct Metal LASER Sintering (DMLS)

Additive Manufacturing (AM) refers to a process by which digital 3D design data is used to build up a component in layers by depositing material. [This definition is taken from the International Committee F42 for Additive Manufacturing Technologies (ASTM).]

The three techniques mentioned above, (AM, 3D Printing and DMLS) are essentially similar processes.

Electron Beam Welding

This process is very similar to LASER welding except the process is performed in a vacuum. Instead of a LASER beam as a heat source an electron beam is applied.

Friction Stir Welding

This is a relatively new process where two metallic pieces are bonded together by a rotating tool that metallurgically mixes the adjoining metal into a single piece.

Ultrasonic Welding, Spot Welding, Seam Welding (Sequential “Stitching” with Overlapping Spot Welds), and Resistance Welding

These are welding processes that allow the fabricator to incrementally add metal to an object without excessive heating. An operator can control the welding (heat input) rate to minimize thermal exposure of a thermally sensitive personalizing substance such as DNA.

Pulsed Arc Welding

This is a welding process, usually employing a hand-held tungsten inert gas (TIG) torch. Small droplets of liquid metal from a filler wire are formed by pulsing the arc from the torch. Heat input to the workpiece can be controlled to desired levels. Metal can be added to a form, seams sealed and holes repaired. Metal inert gas welding (MIG) equipment may also be employed for certain tasks. In this process, the weld wire is fed through the torch and the arc is formed from the tip of the wire to the workpiece.

Hammer Forging

Rapid Solidification

Rapid solidification is a process where a molten metal stream is dropped onto a relatively cold rotating surface. The molten metal undergoes solidification at a very high cooling rate.

Powder Atomization

Powder atomization is also a rapid solidification process in which a molten metal stream is atomized by high pressure gas. When an insoluble gas such as argon or helium is used, large particles are sometimes formed which are hollow.

Low Melting Point Alloys for Encasement

Many non-precious alloys are available that melt between room temperature and 100° C. These alloys could encase the personalizing substance by simple casting.

### EXPERIMENTAL

The practice of this invention can be further understood by reference to the following examples, which are provided by way of illustration only are not intended to be limiting.

Materials

Medical grade PMMA (Mw=35 kDa; residual MMA monomer<0.1%) was purchased from Vista Optics Ltd. (Widnes, UK), PVA (Mw=25 kDa; 88% hydrolyzed) was purchased from Polysciences, Inc. (Warrington, Pa., USA). dichloromethane (DCM; Burdick and Jackson, Muskegon, Mich., USA), ethyl acetate (EA; Mallinckrodt, Hazelwood, Mo., USA), and 1-octanol (Sigma-Aldrich, St. Louis, Mo., USA) were analytical grade solvents. Particles were made by solvent evaporation microencapsulation.

### Example 1

### Preparation of Blank Poly(Methyl Methacrylate) (PMMA) Microparticles

Materials and Methods

500 mg of PMMA (about 25,000 MW) was weighed in a 20-ml glass scintillation vial; 15 ml of dichloromethane (DCM) was added to PMMA, vortexed for 30 seconds and sonicated for 5 minutes until solution became clear (1). At this point, the polymer was completely dissolved and there was no particulate matter.

250 ml of surfactant, 1.0% poly(vinyl alcohol) (PVA) (MW≈25,000 Da; 88% hydrolyzed) was poured into a 1-L Virtis® flask (2).

100 ml of 0.5% PVA (MW≈25,000 Da; 88% hydrolyzed) was poured into an 800 ml beaker (3). The beaker was placed under impeller (approximately 0.5 cm from bottom of beaker) with a speed set at 3,000 RPM.

Virtis® Cyclone was set to “55” (13,750 RPM); then 100 microliters of 1-octanol was added to the 1.0% PVA solution (2) and allowed to sit for 5 minutes (4). The PMMA solution (1) was added to (4) in the 1-L Virtis® flask. This mixture was mixed on the Cyclone for 15 minutes at 13,750 rpm.

The content was poured from the Virtis® flask into the 800 ml beaker containing 0.5% PVA (3) and stirred for about 24 hours to form a slurry of particles.

The slurry of particles was poured into 50 ml Eppendorf® tubes, the caps were screwed on and centrifuged for 20 minutes at 4,000 RPM (3345×g). PVA solution was aspirated off using a 50 ml pipette tip; this solution was kept for further evaluation. 40 ml of distilled water was added to tubes; mixed and shaken well until particles were resuspended in distilled water. The caps were screwed back on and centrifuged for an additional 20 minutes at 4,500 RPM. Distilled water was aspirated off using a 50 ml pipette tip. 40 ml distilled water was added to the tubes, mixed and shaken well until particles resuspended in distilled water. The caps were screwed back on and centrifuged for an additional 20 minutes at 4,000 RPM (3345×g). Distilled water was aspirated off using a 50 ml pipette tip. The slurry of particles was combined into one or two tubes, flash frozen and lyophilized for 48-72 hours.

Variation: The steps recited above were repeated with a different mass of PMMA (about 1M MW). The only difference occurred in the formation of the PMMA solution.

In the variation of Example 1, 500 mg of PMMA was weighed (about 1M MW) in a 50-ml Falcon tube; 30 ml of dichloromethane (DCM) was added to PMMA, vortexed (30 seconds) and sonicated (5 minutes) until the solution became clear.

Results

About 80% of PMMA used in this method formed blank PMMA microparticles.

Substantially the same yield was obtained in the variation of Example 1.

### Example 2

### Preparation of Poly(Methyl Methacrylate) (PMMA) Microparticles Containing Low Loading of DNA

Materials and Methods

1000 mg of PMMA (25,000 MW) was weighed in a 40-ml glass scintillation vial (1). DNA amplified at a mitochondrial locus was prepared. DNA was extracted from harvested human buccal mucosal cells by boiling for 10 minutes in the presence of 10% Chelex resin. A portion of the extracted DNA was PCR amplified using the following primers specific to a noncoding region of the human mitochondrial genome (bases 15,971-16411):

5′-TTAACTCCACCATTAGCACC-3′ (SEQ ID NO: 1)

5′-GAGGATGGTGGTCAAGGGAC-3′ (SEQ ID NO: 2)

The PCR product was purified using the Invitrogen PureLink Quick Gel Extraction & PCR Purification Combo kit. A portion of the purified DNA was labeled with AlexaFluor 488, ethanol precipitated to remove excess label, resuspended in water, and mixed with the remaining DNA to produce a solution suitable for encapsulation containing 5.6 nanograms of DNA per microliter. The DNA was dissolved in water, and the concentration of the solution was 5 micrograms per mL (2). About 100 microliters of DNA solution, corresponding to 0.56 microgram, was taken for microparticle preparation.

30 ml of dichloromethane (DCM) was added to the PMMA vial (1). 10 microliters of Span® 80 (sorbitan monooleate) was added to the PMMA solution and bath sonicated for 15 minutes (3). DNA (2) was pipetted into the PMMA solution (3) and mixed at 10,000 rpm for 1 minute to form an emulsion (4).

250 ml of surfactant, 1.0% PVA (MW≈25,000 Da; 88% hydrolyzed), was poured into a 1-L Virtis® flask. Virtis® Cyclone was set to 10000 RPM. 250 microliters of 1-octanol was added to the 1% PVA, mixed for 1 minute and then let to set for 5 minutes (5).

The PMMA-DNA emulsion (4) was added into the 1.0% PVA solution (5) and mixed for 15 minutes at 7,000 rpm (6).

200 ml of 0.5% PVA (MW≈25,000 Da; 88% hydrolyzed) was poured into an 800 ml beaker. The beaker was placed under impeller (approximately 0.5 cm from bottom of beaker) and the impeller speed was set at 3,000 RPM.

The contents from Virtis® flask (6) were poured into the 800 ml beaker containing 0.5% PVA and stirred for approximately 24 hours to form a slurry of particles.

The slurry of particles was poured into 50 ml Eppendorf® tubes, the caps were screwed on and centrifuged for 20 minutes at 4,000 RPM (3345×g). The PVA solution was aspirated off using a 50 ml pipette tip. This solution was kept for further evaluation. 40 ml of distilled water was added to tubes; mixed and shaken well, until particles resuspended in distilled water. Sonication was used, as needed, to break up any particle aggregates stuck to the bottom of the tubes. The caps were screwed back on and centrifuged for an additional 20 minutes at 4,500 RPM. Distilled water was aspirated off using a 50 ml pipette tip. 40 ml distilled water was added to tubes, mixed and shaken well, until particles resuspended in distilled water. The caps were screwed back on and centrifuged for an additional 20 minutes at 4,000 RPM (3345×g). The distilled water was aspirated off using a 50 ml pipette tip. The slurry of particles was combined into one or two tubes, flash frozen and lyophilized for 48-72 hours.

Results

About 60% of PMMA used in this method formed PMMA microparticles with low amounts of DNA.

The morphology of the particles was observed using scanning electron microscopy (SEM). In general, the particles were spherical in shape and had a smooth surface morphology. No pores were visible, even at high magnification (4,000×). The microspheres generally had a particle diameter of 1-2 micrometers. No fragments of polymer or DNA were observed in the micrographs. Observation of these microparticles under a fluorescent microscope revealed that a portion of them contained DNA labeled with AlexaFluor 488.

### Example 3

### Manufacture of Metallic Article Containing DNA Using Cold Processing

Viable DNA can be integrated into a metallic article of jewelry by intimate integration of the DNA material with a precious metal in such a way that destruction of the DNA by either exposure to temperatures in excess of 100° C. or contact with an electrically active metal surface is avoided.

The DNA can be encapsulated in a polymer as described above. The polymer encapsulation acts as a first line of protection for the DNA and can, for example, prevent direct contact with reactive metal surfaces. In a normal earth atmosphere environment, these metals can be recognized by their ability to form a surface compound with one or more of the elements present in air (e.g., O, N and S). An individual polymer capsule can have dimensions measured on the micron scale (i.e., ˜1×10⁶ meter)

The encapsulated DNA can then be combined with a powdered precious metal. According to some embodiments, the encapsulated DNA can be mixed with metal powder followed by uniaxial pressing of the resulting metal powder mixture into a solid form. The uniaxial pressing process is a cold process which causes the powder particles to be pressure welded together. The product resulting from uniaxial pressing retains some porosity. For example, the product can have about 80-90% of theoretical density. The micro-porosity within the material may provide voids which contain the encapsulated DNA.

The morphology of the initial powder particles can be altered to improve the compaction process and to improve the cold pressing characteristics of a given pure metal or alloy. While gas atomized powder is generally spherical, the ability to compress the powder is more challenging and may require greater compaction to achieve mechanical integrity of the final compact. Irregularly-shaped powder that can be produced by water atomization methods or by ball-milling can be used to improve the mechanical strength of the powder compact and provide a greater porosity volume fraction to contain the encapsulated DNA materials. Porosity within a powder compact would also protect the DNA molecules from being mechanically damaged during the cold pressing process. Upon cold pressing the powder compacts there would be a high probability that a large portion of the internal porosity would not be surface connected and would therefore provide a hermetically sealed chamber to protect the DNA sample.

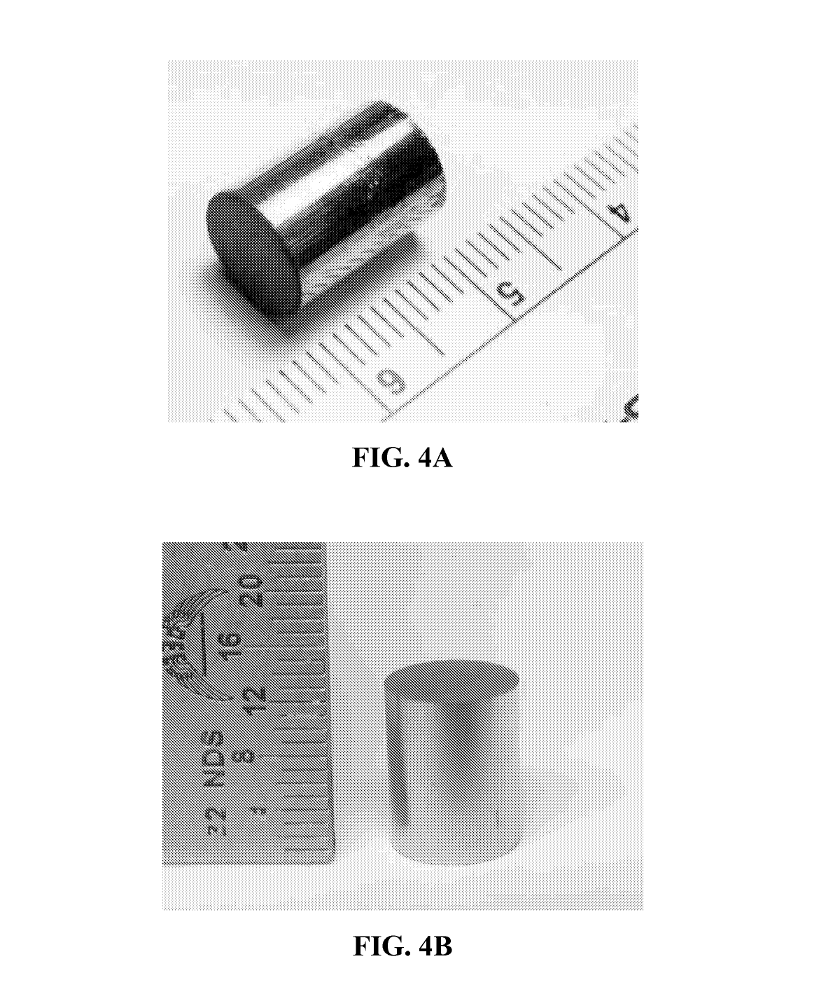

Experiments with uniaxial pressing of metal powder have been successfully completed. Copper powder was used in a small bore cylinder with a machine-fit plug. Pressing trials were conducted with and without a wax lubricant (Acrawax). An example of results obtained is given in Table 1 and the copper capsule product is shown in FIGS. 4A and 4B. The two photographs show capsules as they were removed from a uniaxial pressing cylinder.

TABLE 3
Uniaxial Pressing Trials with Copper Powder

| Specimen | | | | |
|---|---|---|---|---|
| Identification | H288-1 | H288-2 | H288-3 | H288-4 |
| Lubricant (Acrawax) | None | 0.75% | 0.75% | 0.75% |
| Diameter (inches) | 0.314 | 0.314 | 0.314 | 0.314 |
| Length (inches) | 0.454 | 0.393 | 0.433 | 0.464 |
| Cubic Centimeters | 0.576 | 0.499 | 0.549 | 0.589 |
| Peak load (lbf) | 14,959 | 10,166 | 12,162 | 8,098 |
| Compaction Pressure | 193.2 | 131.3 | 157.1 | 104.6 |
| (ksi) | | | | |
| Mass (g) | 4.352 | 3.982 | 4.411 | 4.604 |
| Density (g/cc) | 7.554 | 7.985 | 8.028 | 7.819 |
| Theoretical Density % | 84 | 89 | 90 | 87 |

Not all precious metals can be made into fine powder, but gold (Au) exhibits no problems for manufacture in a range of powder sizes. Accordingly, a metallic article could be readily made from uniaxially pressed Au powder. Because no oxide film forms on Au at ambient environment conditions, high quality pressed products can be made. Dimensions of the cylinder can be adjusted as required.

Small slices of a cylinder can be cut with a diamond saw and polished for insertion in a piece of jewelry, or mechanically attached to a ring (for example) employing similar techniques to those used for mounting precious stones. A small slice cut from the 8 mm dia. cylinder shown in FIGS. 4A and 4B would contain ample DNA for recovery and identification, if required.

Mechanical integrity of uniaxially pressed powders can be quite high, so that jewelry articles other than rings could be shaped with hand tools prior to electroplating with a precious metal to produce a layer of protection and a high-luster finish. Such articles could become components of a necklace, earrings, bracelet fobs, or other articles for attachment to other parts of the human body. In all cases, the DNA would be protected and, if desired would be recoverable for validation-at the expense of destructively testing the piece of jewelry.

One important attribute of this cold processing method is that production of a pressed cylindrical “master-sample” readily permits an archive slice from the cylinder to be preserved by the client. This archive sample could be evaluated for DNA, rather than destruction of a piece of jewelry.

Back-Filling or Cavity Sealing

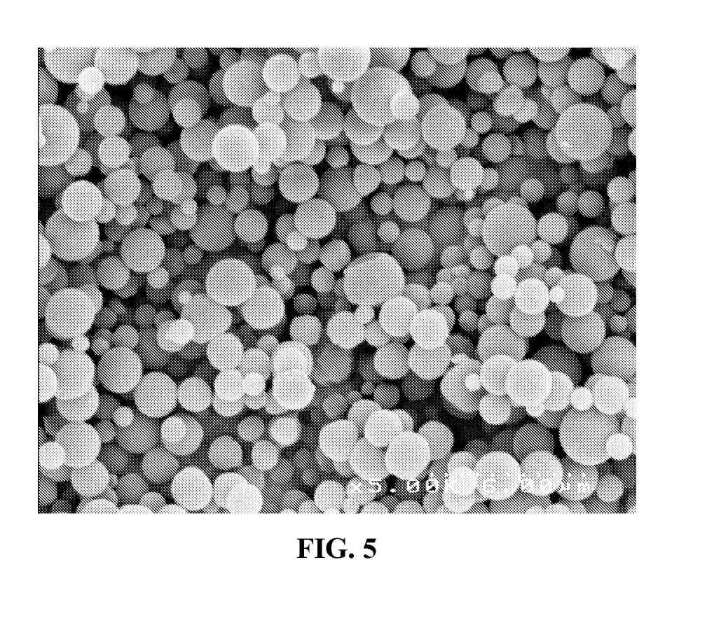

The idea behind this concept is to take advantage of jewelry designs that lend themselves to internal containment of DNA samples. As described above, the DNA can be encapsulated in a polymer to provide a first-line of protection for basic handling of the DNA, and also to facilitate incorporating the very small DNA strands into the article of jewelry. With this technique, numerous strands of DNA will be enclosed in a polymer capsule, which will have dimensions and appearance as shown in FIG. 5. As shown in FIG. 5, the polymer capsules are 1.0-1.5 microns in diameter.

The polymer capsules can be placed in natural jewelry cavities, such as those found in hollow gold hoop earring or hollow rings worn elsewhere. Hermetically sealing of the DNA inside such articles can be accomplished by forming a small hole (e.g., on the order of 1 mm in dia.) in the article of jewelry. The DNA sample can be deposited into the hollow cavity in the article of jewelry using a syringe or similar method. The small hole can then be readily sealed with, for example, a laser using tools and techniques which are in common use. In order to reduce the exposure of the DNA to excessive temperatures, a heat sink can be used during the welding process. Specially designed heat sinks made of water cooled copper can be used. The heat sink components can fit snugly against the jewelry article and reduce thermal exposure of the DNA.

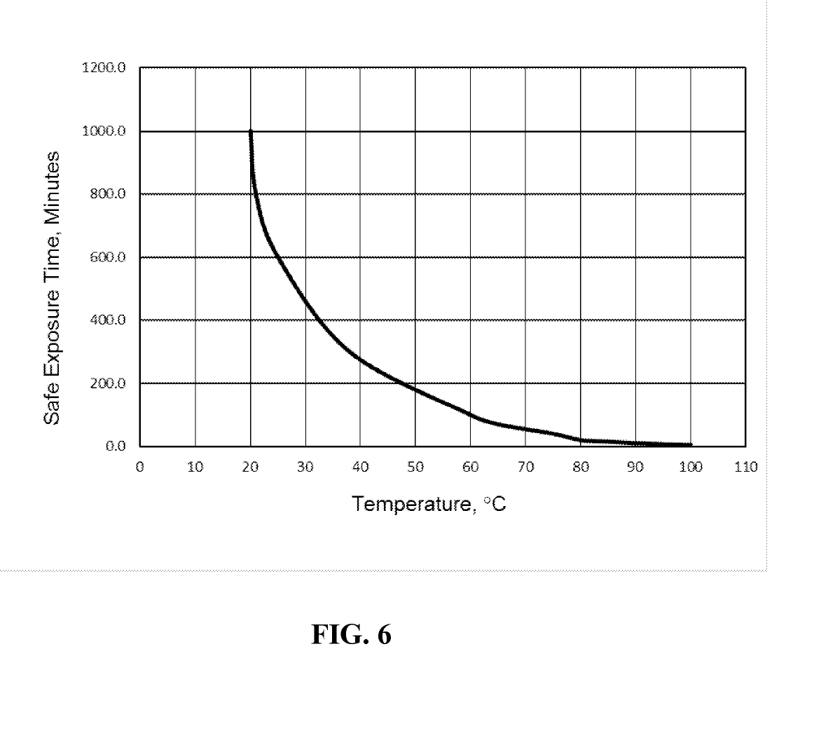

FIG. 6 is a graph showing safe exposure time as a function of temperature for DNA. As shown in FIG. 6, there is essentially no time limit if the exposure temperatures are near ambient, but at 100° C. the DNA strands will survive for only five minutes. Temperatures above 100° C. for any length of time can damage the DNA to some extent.

In some applications, the technique of cold burnishing can be applied. For example, the soft (e.g., gold) metal can be worked by hand until it closes the small hole. After cold burnishing and polishing, all indications of the hole on the outer surface of the article of jewelry can be removed.

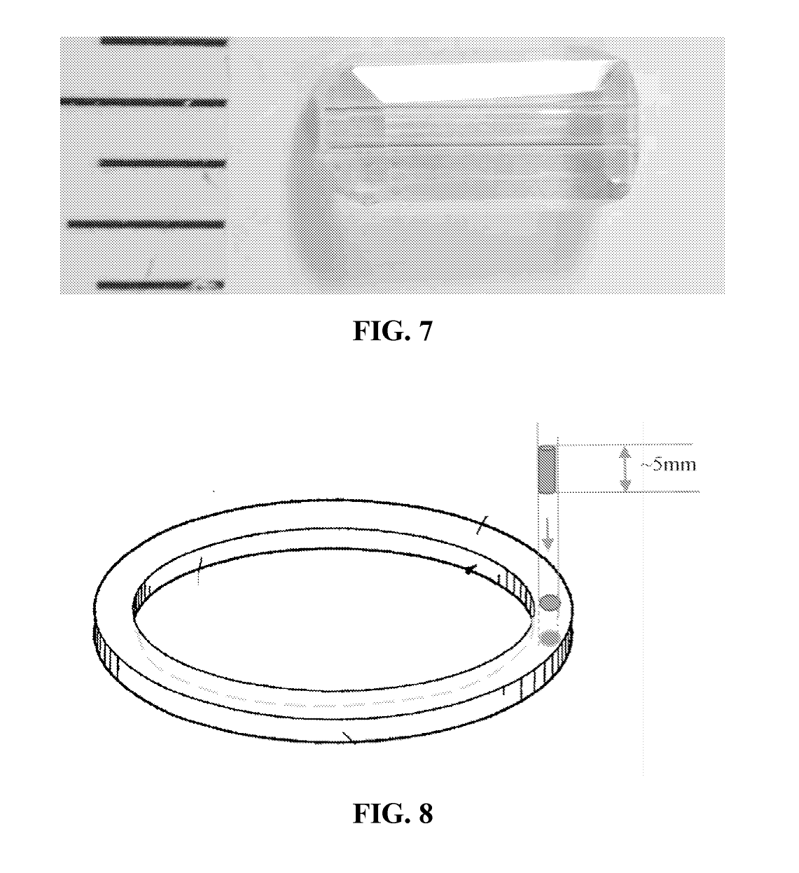

If enclosure of a DNA/polymer sample cannot be safely accomplished without concern for critical temperature exposure, a second line of defense for these embodiments can be employed. According to some embodiments, polymer encapsulated DNA can be placed inside a small rigid structure such as a small bead or tube. According to some embodiments, the bead or tube can be a quartz bead or tube. According to some embodiments, a quartz bead having a wall thickness of about 0.5 mm and bore diameter of <1.0 mm can be used. A typical article, represented by a quartz-crystal glass bead is shown in FIG. 7 (scale is 1/16″: Each division=1.6 mm). The polymer encapsulated DNA sample can be placed inside a small rigid tube and the open ends of the tube can be sealed (e.g., with epoxy). The sealed tube can then be inserted into a cavity in an article of jewelry.

A cavity could be made in a wedding band, for example, by drilling a small hole axially through the width of the band. A cavity having dimensions of 1.5 mm dia. and ˜5 mm long would be sufficient for inserting a polymer encapsulated DNA sample encased in rigid enclosure such as a quartz bead or tube. Laser-sealing of the small holes, with heat sink tooling used to control thermal flux in the ring, would then leave the ring basically “as-new”. A sketch of this concept is shown in FIG. 8.

### Example 5

### Additive Manufacturing/3D Printing/Direct Metal LASER Sintering (DMLS)

Additive Manufacturing (AM) refers to a process by which digital 3D design data are used to build up a component in layers by depositing material. This definition is taken from the International Committee F42 for Additive Manufacturing Technologies (ASTM).

The three techniques mentioned above, additive manufacturing (AM), 3D printing and direct metal laser sintering (DMLS) are similar processes. For the purposes of this disclosure, 3D printing is the most pertinent descriptor, and will be used in the following paragraphs.

The 3D Printing process involves building up computer-generated shapes layer-by-layer until a 3D form is produced. The building process forms one 2D layer at a time. A laser beam is used to melt the metal powder in a layer that may be a fraction of a millimeter thick. Powder not melted is removed, and a new powder deposit is placed over the form in preparation for the laser to build on the prior layer. Considerable complexity is added to the standard process, because waste metal powder must be carefully managed and recycled.

The laser welding process generates heat, and this is an area of concern for implanting DNA into a jewelry object, such as a necklace, bracelet or ring. As described above, the DNA sample can be encapsulated in a polymer and the polymer encapsulated DNA can be, in turn, sealed inside a rigid capsule such as a quartz capsule. According to some embodiments, a 3D printer can be used to build up a shape with a hollow internal area large enough to accommodate the quartz capsule. Printing can be stopped when the article is partially formed and the capsule placed inside the cavity. The 3D printing process can then re-started to complete the cavity.

It has been demonstrated that the quartz capsule can be recovered from the jewelry object made using a 3D printing process and that the DNA contained within the capsule remains viable after recovery. The thermal protection offered by the quartz capsule in the trial geometry is sufficient to protect the DNA from temperatures encountered during the 3D printing process.

In order to determine the temperatures encountered by a quartz encapsulated sample during 3D printing, an experiment was conducted in which a thermocouple embedded in a quartz capsule and contained in a pressed copper powder cylinder (simulating gold) was used to monitor temperature as the 3D printing process progressed. Results of this trial indicated that the maximum internal temperature experience by the quartz capsule is about 80° C.

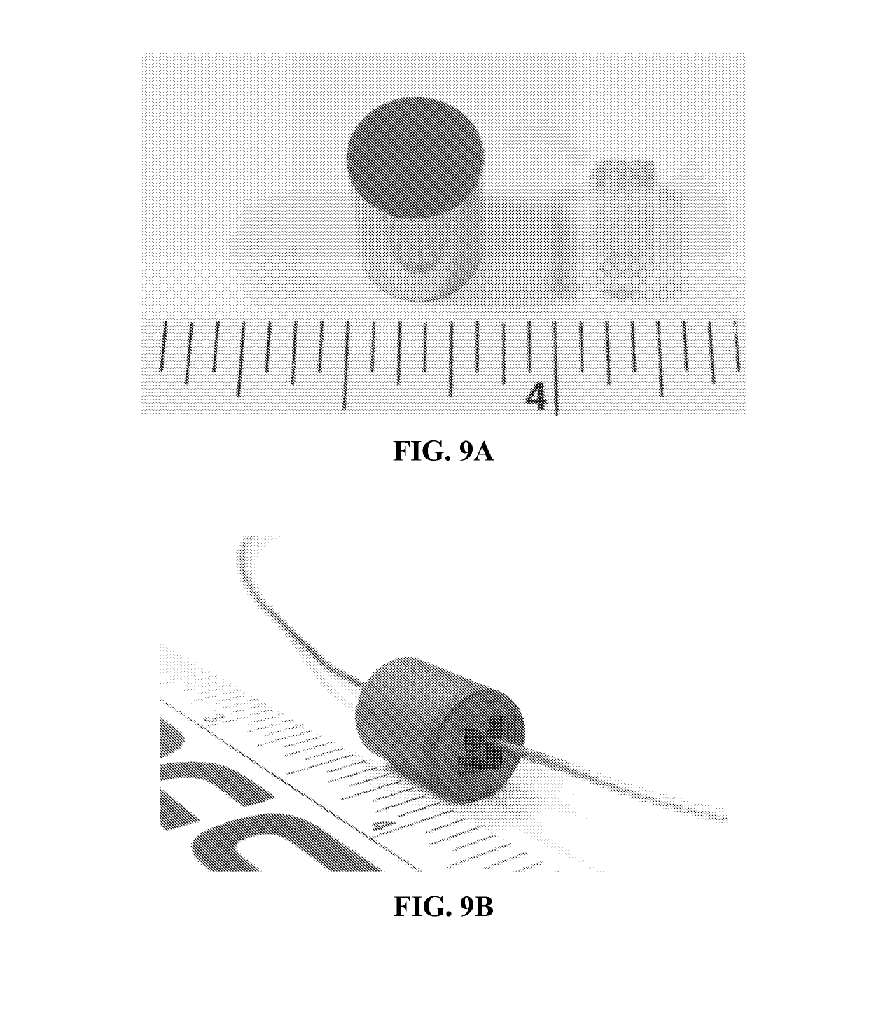

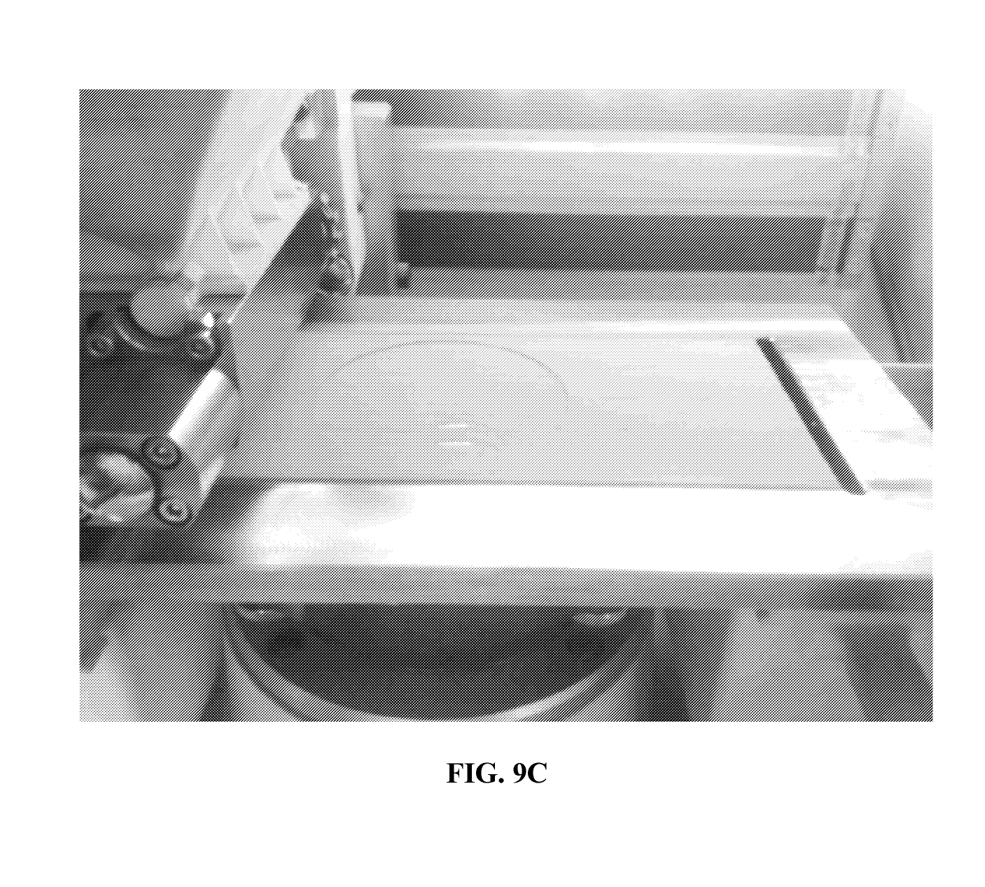

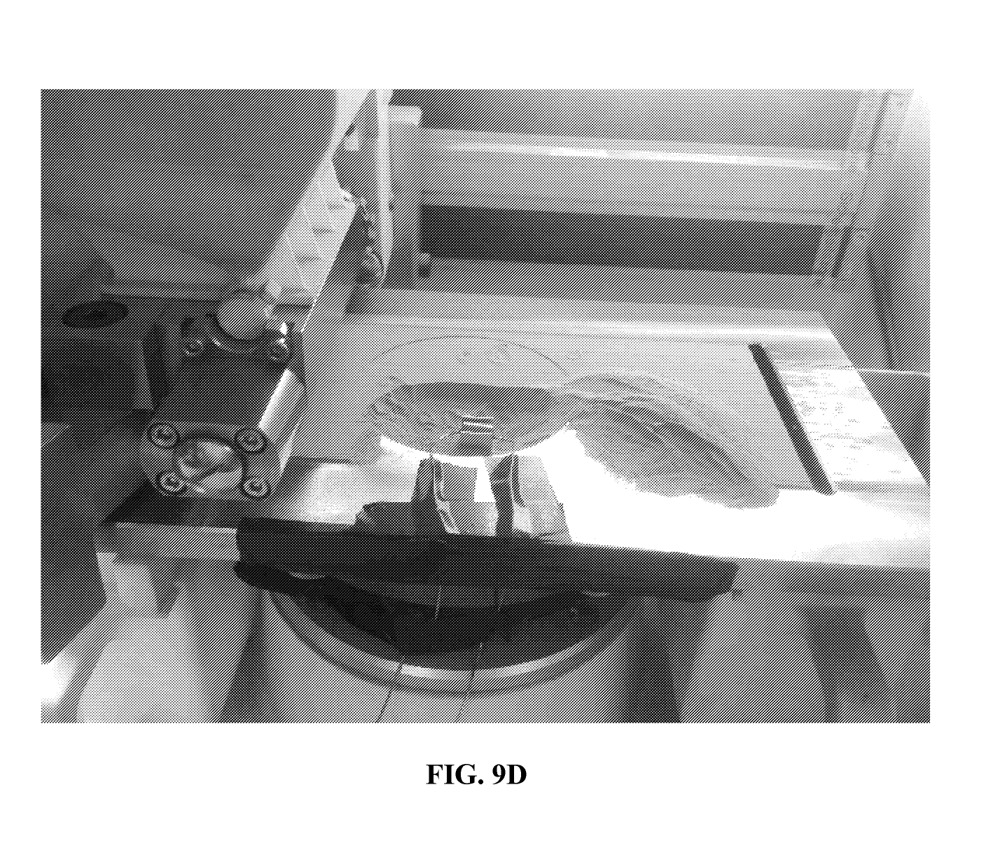

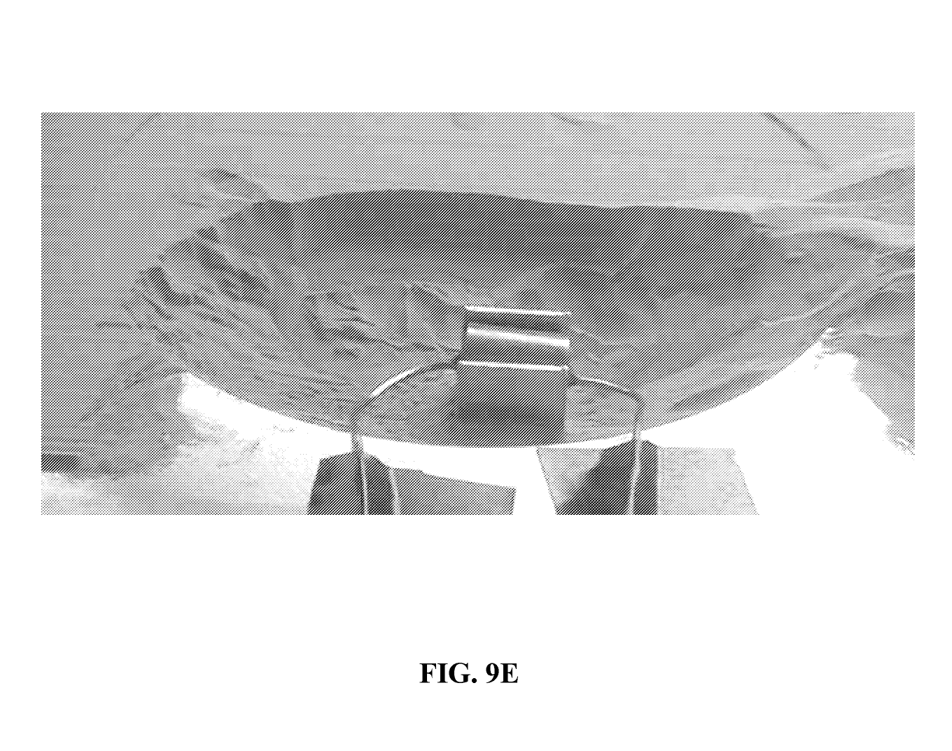

Illustrations of components involved in this temperature measurement experiment using a 3D printing technique are shown in FIGS. 9A-9E. FIG. 9A shows a pressed copper powder cylinder (left) and a quartz bead (right). As shown in FIG. 9B, a thermocouple is embedded in the quartz bead which is embedded in a pressed copper powder cylinder. This thermocouple assembly was used in a 3D printing technique to determine the temperatures encountered by a material within the quartz bead during a 3D printing process. As shown in FIG. 9C, the thermocouple assembly is shown on the 3D printer at a mid-stage of completion wherein the arrows indicate the fused metal structure of the partially completed prototype. FIG. 9D shows the un-melted gold powder removed to reveal the laser welded 3D shape of the partially completed prototype. FIG. 9E shows the partially completed 3D gold prototype with embedded copper/thermocouple assembly prior to completion of the structure.

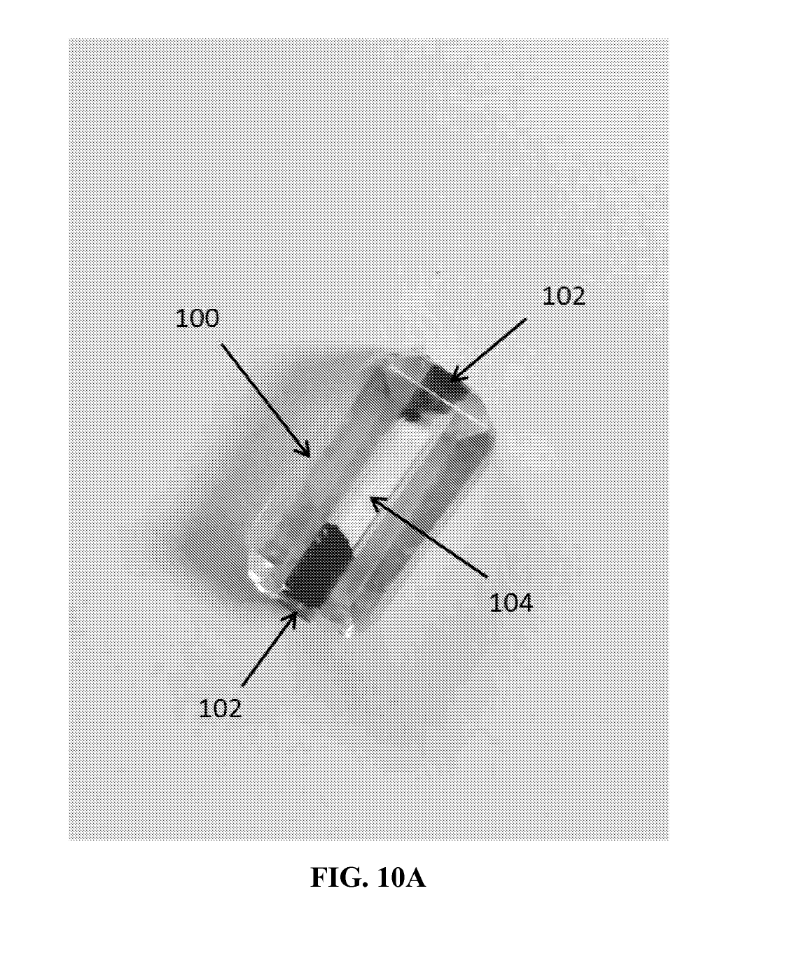

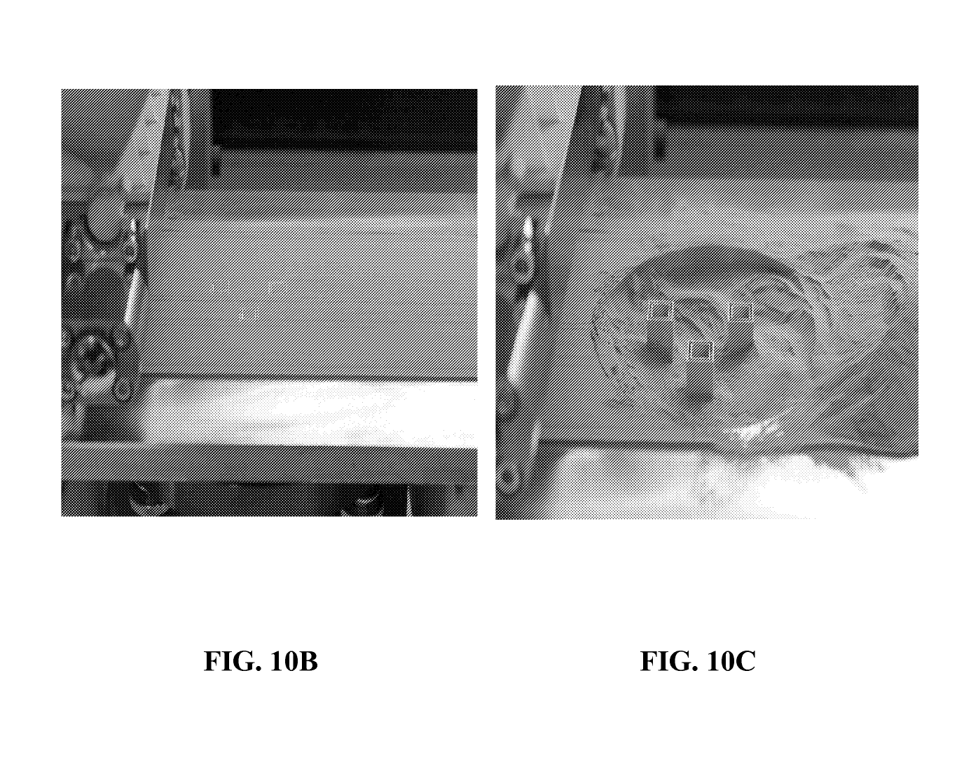

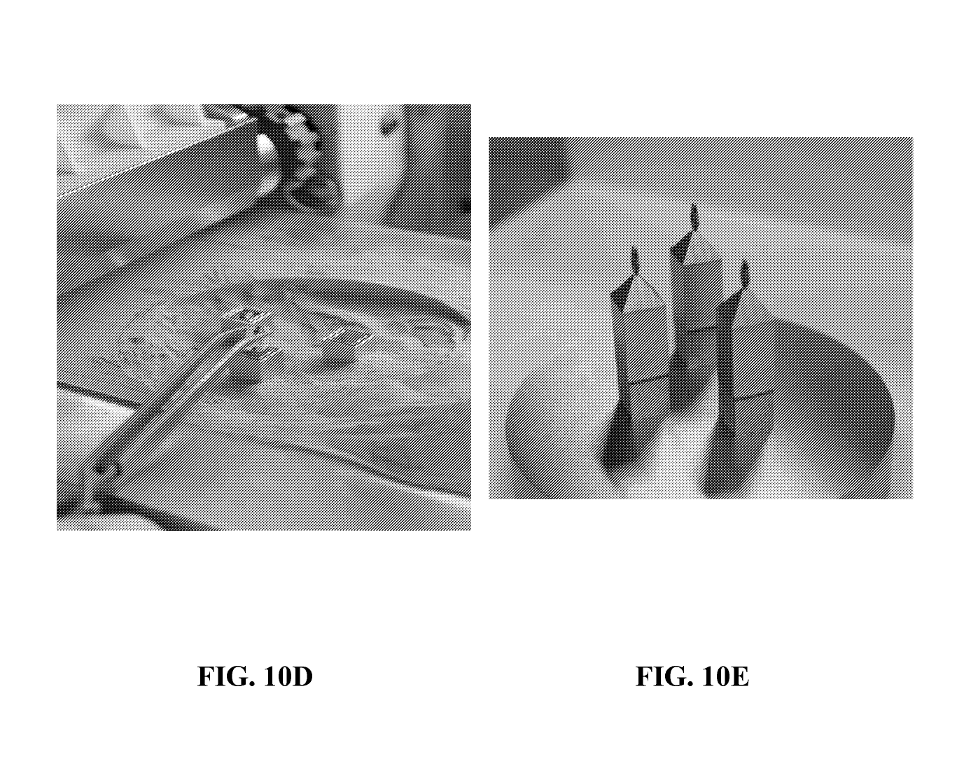

FIG. 10A is a photograph showing a quartz capsule containing polymer encapsulated DNA wherein a clay filler is used to plug the openings in the quartz capsule. FIGS. 10B-10E are photographs showing the direct metal laser sintering (DMLS) of a rose gold powder to form a metallic article of jewelry enclosing the quartz capsule of FIG. 10A. FIG. 10B is a photograph during an initial stage of the process. FIG. 10C is a photograph showing the partially fabricated metallic articles prior to insertion of the quartz capsule. FIG. 10D is a photograph showing the quartz capsule being inserted into a cavity in the partially fabricated metallic articles. FIG. 10E is a photograph showing the completed articles.

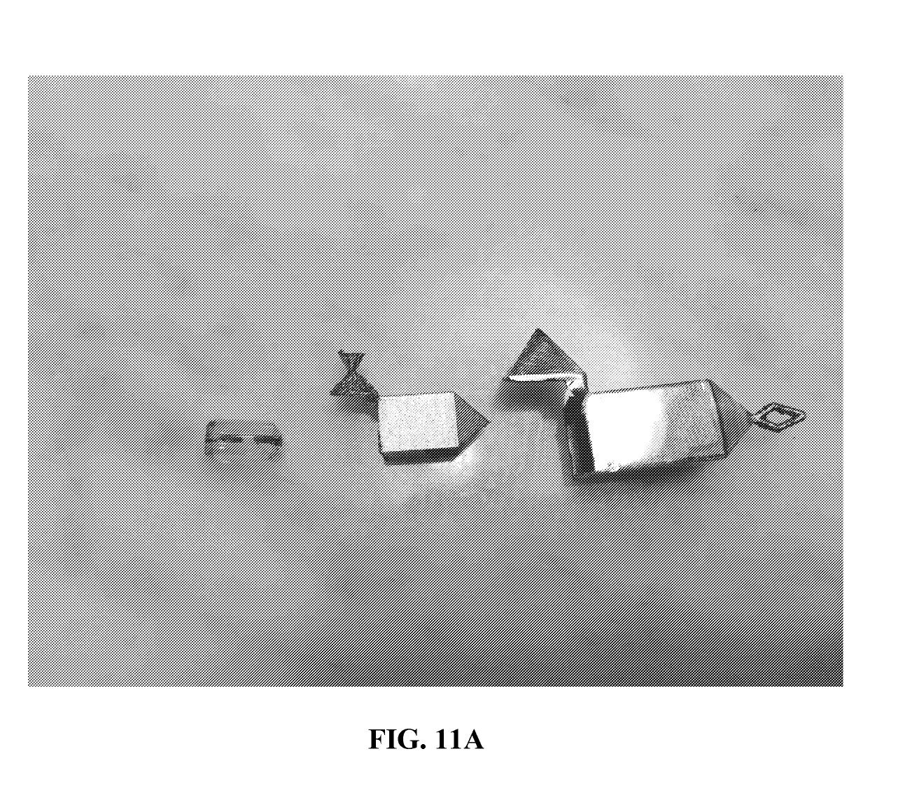

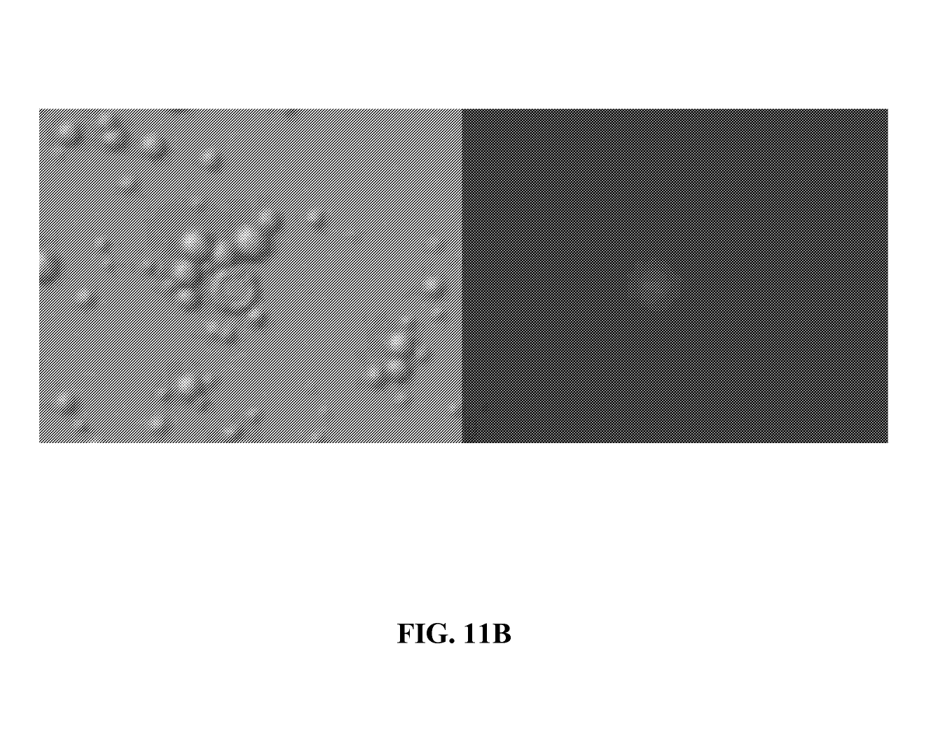

The DNA or other personalizing substance maintains its integrity during the 3D printing process and can be recovered in tact from the article of jewelry. FIG. 11A is a photograph showing the recovery of the quartz capsule containing polymer encapsulated DNA from the metallic article of jewelry. As shown in FIG. 11A, the 3D printed metallic structure has been opened and the quartz capsule containing the DNA has been removed.

The encapsulated DNA, which was covalently labelled with the fluorescent dye Alexa Fluor 488, was visualized after removal from the quartz bead by fluorescence microscopy. Under UV illumination, the DNA was clearly visible in the microparticles. FIG. 11B is a photograph which shows the microparticles under phase contrast microscopy and with UV fluorescence.

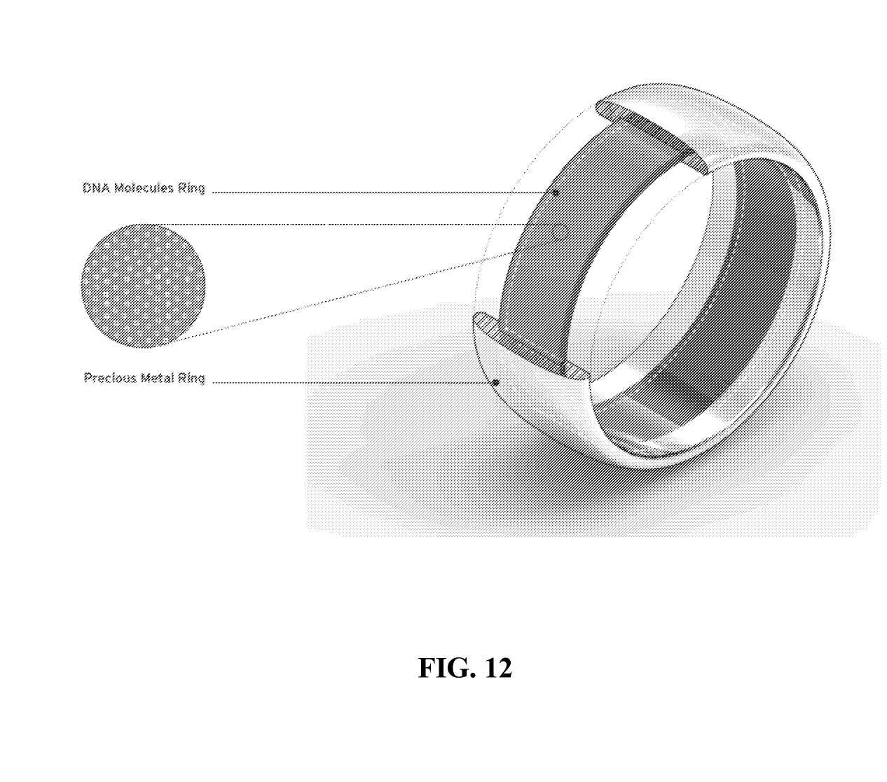

FIG. 12 is a schematic showing a ring having an inner band of a continuous matrix of material containing dispersed DNA.

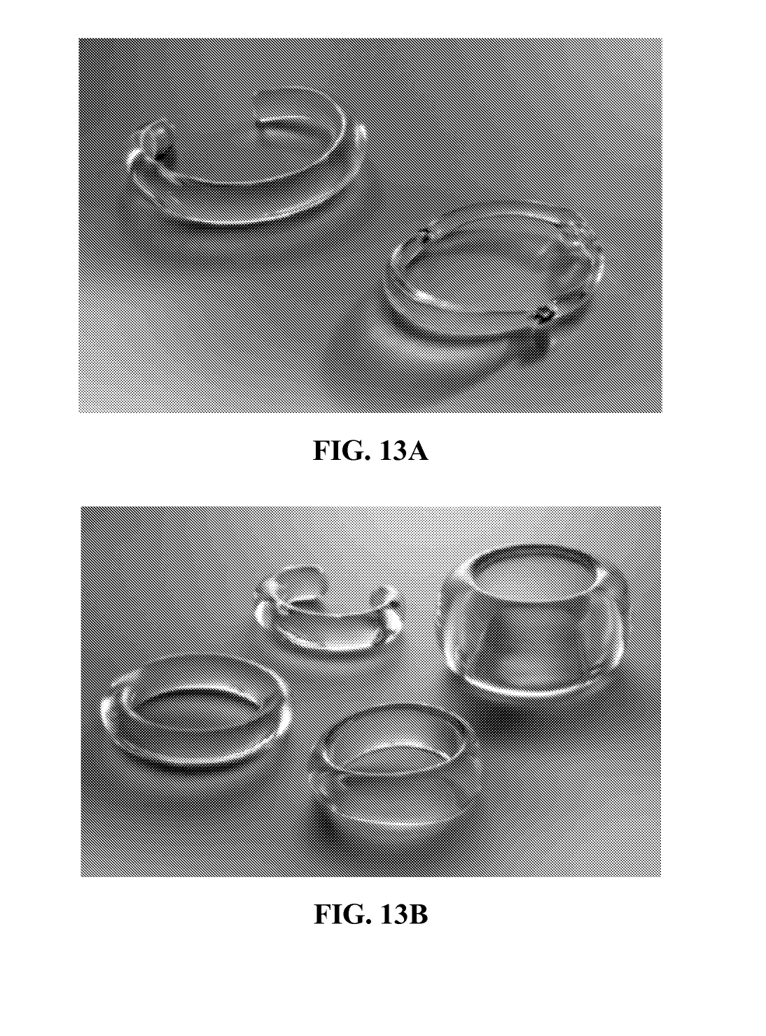

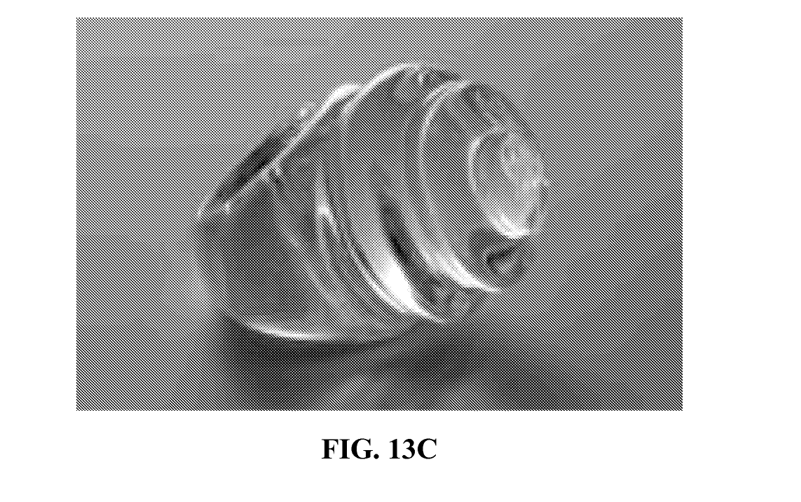

FIGS. 13A-13C are photographs showing various articles of jewelry that can be made from a continuous matrix of material containing dispersed DNA.

The 3D printing approach described above provides considerable design flexibility for jewelry objects made specifically to contain and protect viable DNA. Intricate pendants, bracelets, earrings and rings are the more probable types of precious metal article that can be made with this technique. With miniaturization of the encapsulated DNA, using, for example, micro-bore quartz tube (<1 mm dia.), great care will be needed to ensure the DNA is not exposed to temperatures beyond the 100° C. limit. This can be achieved in a number of ways:
By stopping the 3D printing at frequent intervals to allow heat buildup to dissipate between completion of laser passes
By packing gold powder around the cavity (if not already there) to aid in removal of heat by conduction
By cooling the area with a micro-probe of liquid inert gas, such as nitrogen or argon. This technique would be well-suited to jewelry with an open-structure. After buildup of a cavity and installation of the DNA capsule, a small probe could be placed below the plane of laser construction. With the probe focused on the area containing the DNA, inert gas cooling could be used immediately after a laser-pass until buildup of the structure was a sufficient distance beyond the DNA location. The jet of cold gas would disperse powder particles between the nozzle tip and the jewelry article, but the subsequent powder sweep, which lays down the next 2D layer, would automatically fill in any spaces formed by flow of the inert gas.

Encapsulation of DNA Using Polymer Solution Casting

Polymer solution casting is a manufacturing process that is used to make polymeric films which are typically in the shape of a single or multi-layered composition commonly utilized in the medical device industry, in plastic fabrication. This manufacturing technology is unique in that the process does not require conventional extrusion or injection molding technologies, yet can be used to readily incorporate components and features traditionally produced by these processes.

The process involved a first step in which the polymer of choice is dissolved in a suitable solvent in concentrations ranging from 0.1% w/v up to 50% w/V of polymer and solvent. According to some embodiments, the polymers can be non-erodible and durable.

After the step of dissolving the polymer, the personalizing substance can be dissolved (if necessary) and dispersed in the polymer solution. In the case of DNA, the DNA could be first dissolved in an aqueous solution and then dispersed in the polymer solution. Alternatively, the DNA can be precipitated with calcium for example and then dispersed in the polymeric solution. Other personalizing substances as described above can also be used in a polymer solution casting process. According to some embodiments, the personalizing substance used in the polymer solution casting process is a piece of hair from a human or animal. According to some embodiments, the personalizing substance is a solid particle. According to some embodiments, the personalizing substance is a liquid. When a liquid personalizing substance is used, the liquid can be dried prior to incorporating the substance into the polymer solution.

According to some embodiments, the polymer solution comprising the personalizing substance can be cast into a mold having a shape that useful for the specific application. After casting, the organic solvent can be removed (e.g., by evaporation at room temperature). The resulting product comprises a continuous matrix of a polymer comprising the personalizing substance dispersed therein.

The advantage of the system is that solvent casting can be done in a simple series of steps and in any shape that is desired. Some examples of shapes which could be cast using this technique are depicted in FIGS. 13A-13C. FIG. 13A is a photograph showing examples of bracelets which could be cast using a polymer solution casting process. FIG. 13B is a photograph showing examples of rings which could be cast using a polymer solution casting process. FIG. 13C is a photograph showing a ring which could be cast using a polymer solution casting process.

A polymer solution casting process as set forth above can also be used to form an inlay containing a personalizing substance in an article of metallic jewelry. A ring comprising an inlay of a personalizing substance dispersed in a continuous matrix on the inner band is shown in FIG. 12. The inlay can be made using a solution casting process as described above. For example, a polymer solution containing the personalizing substance can be cast into a cavity in an article of metallic jewelry. As shown in FIG. 12, the cavity can be on the inner band of a ring.

A polymer solution casting process as described above can be used to make a thin film incorporating the personalizing substance. Multi-layer articles can also be made using the solution casting process. According to some embodiments, the material properties (e.g., strength, color, lubricity, etc.) of the layers of the article can be different. According to some embodiments, the article can include different layers and a different personalizing substance can be added to each layer. Alternatively, one or more personalizing substances can be incorporated into a single layer or a single monolithic casting.

The solution casting process allows the design the individual layers resulting in a feature-rich single-piece construction. This process also allows other components to be incorporated into the structure of the part during the layering processes.

Another notable advantage of polymer solution casting technology is that the total manufacturing cost for both prototyping and production volumes are frequently less than the conventional technologies. This cost benefit results from the use of inexpensive molds coupled with the scalability and adaptability of the manufacturing line. As a result, new products and processes are readily developed and implemented, facilitating cost-effective creation of very feature rich and complex structures.

According to some embodiments, the polymer used in the polymer solution casting process can be an acrylic polymer. Exemplary acrylic polymers include but are not limited to poly(methyl methacrylate) (PMMA). According to some embodiments, the polymer solution comprises a colorant.

Additional method of polymer fabrication can also be used. Such additional methods include, but are not limited to, in situ polymerization in which a solution including monomers and a personalizing substance are mixed and the monomers are then polymerized. As with polymer solution casting, in situ polymerization can be carried out in a mold or in a recess in an article such as a metallic article of jewelry to form an inlay. In addition, other polymer fabrication methods such as melt extrusion or dry extrusion can be used to incorporate the personalizing substance into a polymer. The conditions to which the personalizing substance is subjected during processing (e.g., time, pressure, temperature, etc.) should not result in degradation of the personalizing substance.

While the foregoing specification teaches the principles of the present invention, with examples provided for the purpose of illustration, it will be appreciated by one skilled in the art from reading this disclosure that various changes in form and detail can be made without departing from the true scope of the invention.

What is claimed is:

1. A composition comprising:
a metal powder; and
a personalizing substance.

2. The composition of claim 1, wherein the metal powder is a precious metal powder.

3. The composition of claim 1, wherein the personalizing substance comprises DNA.

4. The composition of claim 1, wherein the personalizing substance comprises DNA encapsulated in a polymer.

5. A method of incorporating a biological material into a metal article comprising:
encapsulating the biological material in a polymer;
mixing the encapsulated biological material with a metal powder; and
forming the resulting mixture into a metal article incorporating the encapsulated biological material;
wherein the encapsulated biological material is integrated into and retains its structural integrity in the metal article.

6. The method of claim 5, wherein the biological material is encapsulated in a polymer.

7. The method of claim 5, wherein the biological material comprises DNA.

8. The method of claim 5, wherein forming comprises applying pressure to the mixture.

9. The method of claim 5, wherein forming comprises uniaxially pressing the mixture to form the metal article.

10. The method of claim 5, wherein the metal powder comprises a precious metal powder.

11. The method of claim 5, wherein the metal powder comprises gold powder.

12. A metal article made by the method of claim 5.

13. An article of jewelry comprising the metal article of claim 12.

14. A method of incorporating a biological material into metal comprising:
encapsulating the biological material in a polymer;
forming the metal around the encapsulated genetic material to encase the genetic material;
wherein the metal is formed around the encapsulated biological material using a cold, warm or hot metallurgical process; and
wherein the encapsulated biological material is integrated into and retains its structural integrity in the metal article.

15. The method of claim 14, wherein forming the metal around the encapsulated biological material comprises forming the metal using an additive manufacturing process.

16. The method of claim 14, wherein forming the metal around the encapsulated biological material comprises forming the metal using a 3D printing process.

17. The method of claim 16, wherein the metal is a precious metal.

18. The method of claim 1, wherein the biological material is encapsulated in a polymer.

19. A metal article comprising:
a biological material;
a metallic body;
wherein the metallic body is formed around the biological material such that the biological material is encased in the metallic body.

20. An article of manufacture comprising:
polymer encapsulated biological material;
wherein the polymer encapsulated biological material is contained in a rigid capsule.

21. The article of claim 20, wherein the biological material is DNA.

22. The article of claim 20, wherein the rigid capsule is a quartz capsule.

23. A method comprising:
dispersing a personalizing substance in a polymer solution;
casting the polymer solution containing the personalizing substance;
subsequently removing the solvent to form a polymer article incorporating the personalizing substance.

24. The method of claim 23, wherein the personalizing substance is a biological material.

25. The method of claim 23, wherein the personalizing substance is DNA.

26. The method of claim 23, wherein the polymer is an acrylic polymer.

27. The method of claim 23, wherein the polymer solution comprises a colorant.

28. The method of claim 23, wherein casting comprises casting the polymer solution containing the personalizing substance into a cavity in a metallic article of jewelry.

29. The method of claim 23, wherein casting comprises casting the polymer solution containing the personalizing substance into a cavity of a mold.


SEQUENCE LISTING (2 sequences)

SEQ ID NO: 1 - DNA, 20 bp, Artificial Sequence
  Primer specific to a noncoding region of the human mitochondrial genome (bases 15,971-16411)
ttaactccaccattagcacc

SEQ ID NO: 2 - DNA, 20 bp, Artificial Sequence
  Primer specific to a noncoding region of the human mitochondrial genome (bases 15,971-16411)
gaggatggtggtcaagggac